(19) United States
(12) Patent Application Publication
(10) Pub. No.: US 2026/0350928 A1
(43) Pub. Date: Nov. 5, 2026

(54) METAVERSE CUSTOMIZATION

(71) Applicant: International Business Machines Corporation, Armonk, NY (US)

(72) Inventors: Kara A. SMOOT, Baltimore, MD (US); Stephen RECHTMAN, Highland Park, NJ (US); Jeremy R. FOX, Georgetown, TX (US); Vinod Anandram VALECHA, Pune (IN); Jennifer M. HATFIELD, Portland, OR (US)

(21) Appl. No.: 19/181,020

(22) Filed: Apr. 16, 2025

(51) Int. Cl. G06T 19/00; G06T 13/40; G06V 10/70

(52) U.S. Cl. CPC G06T 19/006; G06T 13/40; G06V 10/70

(57) ABSTRACT

Methods, computer program products, and systems are presented. The method computer program products, and systems can include, for instance: processing historical user data; generating a custom metaverse for a certain user in dependence on the processing, wherein the generating comprises: composing a virtual scene; populating the virtual scene with digital assets; and developing a user avatar that represents the certain user; wherein one or more of the composing, populating, or developing is performed in dependence on result data resulting from the processing historical user data.

### BACKGROUND

Embodiments herein relate to metaverse generating in general and specifically to a customized metaverse.

A metaverse is a computer-generated immersive environment that simulates a virtual world experience. Often rendered in three-dimensional (3D) graphics, a metaverse may replicate real-world characteristics such as physics, environments, and objects. Scenes can include digital assets such as buildings, landscapes, and interactive elements, and may support simultaneous participation by numerous users.

Users engage with the metaverse through avatars—customizable digital representations that navigate, interact, and occupy virtual scenes. Other users can view and interact with an avatar within the shared digital space.

Each user's viewable field is defined by the subset of the scene currently rendered to their metaverse client, including digital assets such as static objects, environmental elements, or other avatars. Rendering of the viewable field is determined by the client software based on loaded geometries, textures, and behavioral state. The system may track object visibility duration to support personalization, behavioral modeling, and engagement analytics.

Data structures have been employed for improving operation of computer system. A data structure refers to an organization of data in a computer environment for improved computer system operation. Data structure types include containers, lists, stacks, queues, tables and graphs. Data structures have been employed for improved computer system operation, e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: processing historical user data; generating a custom metaverse for a certain user in dependence on the processing, wherein the generating comprises: composing a virtual scene; populating the virtual scene with digital assets; and developing a user avatar that represents the certain user; wherein one or more of the composing, populating, or developing is performed in dependence on result data resulting from the processing historical user data.

In another aspect, a computer program product can be provided. The computer program product can include a computer readable storage medium readable by one or more processing circuit and storing instructions for execution by one or more processor for performing a method. The method can include, for example: processing historical user data; generating a custom metaverse for a certain user in dependence on the processing, wherein the generating comprises: composing a virtual scene; populating the virtual scene with digital assets; and developing a user avatar that represents the certain user; wherein one or more of the composing, populating, or developing is performed in dependence on result data resulting from the processing historical user data.

In a further aspect, a system can be provided. The system can include, for example a memory. In addition, the system can include one or more processor in communication with the memory. Further, the system can include program instructions executable by the one or more processor via the memory to perform a method. The method can include, for example: processing historical user data; generating a custom metaverse for a certain user in dependence on the processing, wherein the generating comprises: composing a virtual scene; populating the virtual scene with digital assets; and developing a user avatar that represents the certain user; wherein one or more of the composing, populating, or developing is performed in dependence on result data resulting from the processing historical user data.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a manager system, user equipment (UE) devices, a sensor system, and enterprise systems according to one embodiment;

FIG. 2A and FIG. 2B depict a physical world, and a virtual world, respectively, according to one embodiment;

FIG. 3 is a flowchart illustrating a method for performance by a manager system interoperating with UE devices, a sensor system, and enterprise systems according to one embodiment;

FIG. 4A depicts a clustering machine learning model according to one embodiment;

FIG. 4B depicts clustering analysis according to one embodiment;

FIG. 5 is a flowchart depicting a method for performance by a system according to one embodiment;

FIGS. 6A-6F is a flowchart depicting a method for performance by a system according to one embodiment;

FIG. 7 depicts an artificial neural network (ANN) according to one embodiment;

FIG. 8 depicts a computing environment according to one embodiment.

### DETAILED DESCRIPTION

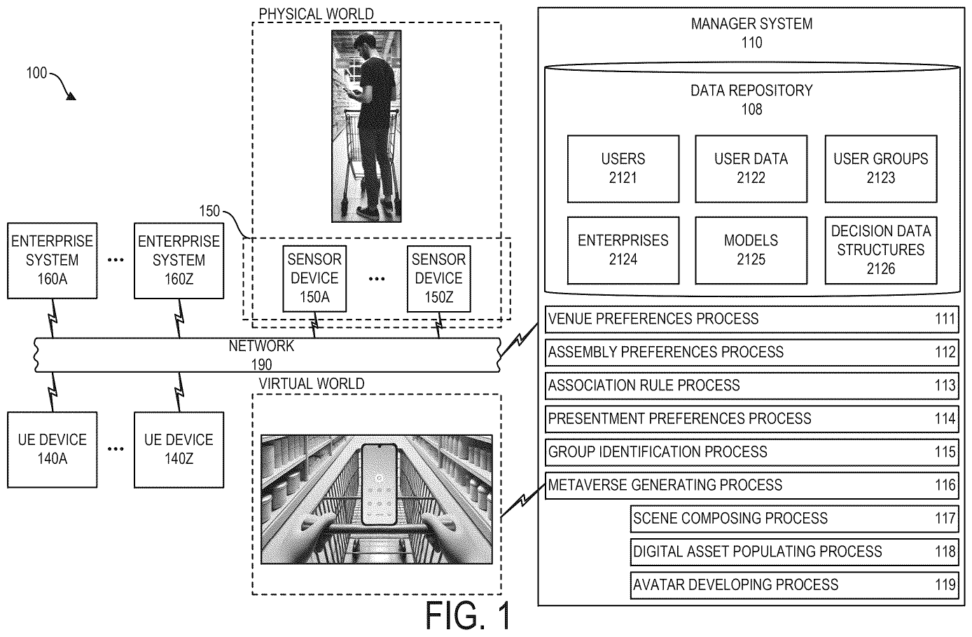

A system for use in customizing a metaverse to a user is shown in FIG. 1. System 100 can include manager system 110 having an associated data repository 108, user equipment (UE) devices 140A-140Z, sensor system 150, comprising a plurality of sensor devices 150A-150Z, and enterprise systems 160A-160Z. UE devices 140A-140Z, sensor system 150, and enterprise systems 160A-160Z can be computing node-based systems that are in communication with manager system 110 via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

In one embodiment, manager system 110 can be external to each of UE devices 140A-140Z, sensor system 150, and enterprise systems 160A-160Z. In one embodiment, manager system 110 can be co-located with one or more UE devices of UE devices 140A-140Z, one or more sensor devices of sensor devices 150A-150Z, and/or one or more enterprise systems of enterprise systems 160A-160Z.

A fundamental aspect of operation of a computer system is its interoperation with human actors. By increasing the accuracy and reliability of information presented to human users, embodiments herein increase the level of engagement of human users for enhanced computer system operation. In one aspect, manager system 110 can generate a metaverse for use by a certain user in a manner that is in dependence on the historical experience of the certain user, thus increasing engagement of a computer to the certain user. In a further aspect, selections can be made by the certain user who is interoperating with the custom-generated metaverse, and actions can be performed in dependence on the metaverse-initiated selections.

UE devices 140A-140Z can be associated with respective users of the system. Users can include, e.g., individual users who interoperate with a metaverse generated by manager system 110. Users can also or alternatively include agent users who are users associated with an enterprise of enterprise systems 160A-160Z. UE devices 140A-140Z can be provided, e.g., by smartphones equipped with cameras and additional sensors, tablets, laptops, PCs, custom consoles, and the like.

Sensor system 150 can include a plurality of sensor devices 150A-150Z disposed to sense the location of persons in respect to at least one geofence array disposed in a location coordinated with the location of a venue. Sensors of sensor system sensor devices 150A-150Z of sensor system 150 can include, e.g., camera imaging sensors, GPS sensors, smartphones carried by persons. Sensor devices 150A-150Z of sensor system 150 can include, e.g., sensors carried by persons, which transmit radio signals to base stations, e.g., for triangulation-based location sensing, and/or can include such base stations which detect radio signals transmitted from locations of users for performance of location sensing. Sensor devices 150A-150Z in some use cases can be co-located with UE devices of UE devices 140A-140Z. For instance, a user's smartphone can define both a UE device of UE devices 140A-140Z and a sensor device of sensor devices 150A-150Z. Sensor system 150 can be deployed to sense, with camera imaging, attributes of an environment of users, as well as items within an environment of a user. Camera images obtained with use of a camera image device can be subject to pattern recognition processing.

Enterprise systems 160A-160Z can be associated with a number of different types of enterprises, e.g., social media system enterprises, payment processing enterprises, item acquisition enterprises, e.g., enterprises that operate retail store venues, geospatial mapping enterprises, and the like. Manager system 110 can run various processes.

In one embodiment, an enterprise system of enterprise systems 160A-160Z can include a social media system. A social media system can include a collection of files, including, for example, HTML files, CSS files, image files, and JavaScript files. The social media system of enterprise systems 160A-160Z can be a social website such as FACEBOOK® (Facebook is a registered trademark of Facebook, Inc.), X® (formerly known as Twitter®) (X and Twitter are registered trademarks of X Corp.), LINKEDIN® (LinkedIn is a registered trademark of LinkedIn Corporation), or INSTAGRAM® (Instagram is a registered trademark of Instagram, LLC). Computer-implemented social networks incorporate messaging systems that are capable of receiving and transmitting messages to client computers of participant users of the messaging systems. Messaging systems can also be incorporated in systems that have minimal or no social network attributes. A messaging system can be provided by a short message system (SMS) text message delivery service of a mobile phone cellular network provider, or an email delivery system. Manager system 110 can include a messaging system in one embodiment. During a process of registration wherein a user of system 100 registers as a registered user of system 100, a user sending registration data can send, with permission data defining the registration data, a permission that grants access by manager system 110 to data of the user within the social media system. On being registered, manager system 110 can examine data of the social media system, e.g., to determine whether first and second users are in communication with one another via a messaging system of the social media system. A user can enter registration data using a user interface displayed on a client computer device of UE devices 140A-140Z. Entered registration data can include, e.g., name, address, social media account information, other contact information, biographical information, background information, preference information, and/or permissions data, e.g., can include permissions data allowing manager system 110 to query data of a social media account of a user provided by the social media system, including messaging system data and any other data of the user. When a user opts in to register into system 100 and grants system 100 permission to access data of the social media system, system 100 can inform the user as to what data is collected and why, that any collected personal data may be encrypted, that the user can opt out at any time, and that if the user opts out, any personal data of the user is deleted.

In one embodiment, an enterprise system of enterprise systems 160A-160Z can include a geoclassification system. The geoclassification system can associate venues with spatial coordinate ranges associated with the venues. The geoclassification system can include enhanced spatial maps pre-marked with tags to indicate uses associated with map features. Map features can include venues having associated venue areas including venue building areas and/or associated venue parking areas. An enhanced map can include tags specifying usage classifications of venues, e.g., residential, business, public, and the like. An enhanced map can be tagged to tag features of a map including, e.g., roads, bodies of water, and infrastructure features such as building walls (exterior and interior) defining enterprise venues. In some cases, an enhanced map can be tagged so that different parts of a building are tagged differently, e.g., a doorway can be tagged differently from a conference room. The geoclassification system can provide data tags associated with locations that specify uses associated with various locations. The geoclassification system can cognitively map venues identified by venue identifiers, e.g., names, addresses, classifications, and the like, to coordinate location ranges associated with the various venues. Accordingly, manager system 110 querying the geoclassification system, with location data in the form of coordinate location data, can return an identified venue. Further, the geoclassification system can cognitively map venues that are listed in the geoclassification system with uses associated with such venues, e.g., whether such venues are for residential use or business use, and include a variety of additional or alternative use classifications, e.g., public use, roadway use, waterway use, and the like. An enhanced map can be tagged to tag features of a map, including, e.g., roads, bodies of water, and venues. Venues can be provided, e.g., by open spaces, such as developed open spaces or undeveloped open spaces, buildings such as open-roof buildings or closed-roof buildings, and/or open spaces associated with buildings, such as a building associated with a parking lot. For each venue, the geoclassification system can associate, e.g., identifiers for the venue, ranges and coordinate locations associated with the venue, features associated with the venue, such as building infrastructure features, parking lot features, and other features. The geoclassification system, according to one embodiment, can be provided by GOOGLE MAPS® (GOOGLE MAPS® is a registered trademark of Google, Inc.).

Data repository 108 can store various data. Data repository 108, in users' area 2121, can store data on users of system 100. Users of system 100 can include, e.g., registered users and guest users. On registration of the user to system 100, manager system 110 can assign a universally unique identifier (UUID) to such users. Various user data can be associated with the users with use of such user IDs.

In user data area 2122, data repository 108 can store user data. User data can include, e.g., social media posts, item acquisition data specifying items that have been acquired by users, location data timestamped over time creating a record of user locations over time, and the like.

In user groups area 2123, data repository 108 can store data on groups of users who use system 100. In one aspect, manager system 110 can customize metaverses for individual users. In some use cases, there may be insufficient data for manager system 110 to appropriately customize a metaverse. In such instances, manager system 110 may customize an attribute of a metaverse, e.g., a scene, digital asset, avatar, and the like, based on a user group association of a user rather than, or in addition to, user data of the user.

In enterprises area 2124, data repository 108 can store data on enterprises of enterprise systems 160A-160Z who are supporting system 100. Enterprises referenced in enterprises area 2124 can include, e.g., item acquisition enterprises which make items available for acquisition, social media enterprises, payment processing enterprises, geospatial mapping enterprises, location services enterprises, and the like.

In models area 2125, data repository 108 can store predictive models that have been trained with training data by manager system 110 by machine learning. In decision data structures area 2126, manager system 110 can store decision data structures for return of action decisions by manager system 110.

Manager system 110 can run various processes. Manager system 110 running venue preferences process 111 can include manager system 110 ascertaining venue preferences of a user. For return of venue preferences of the user, manager system 110 can track location data of a user over time and can ascertain venues visited by the user. Manager system 110 can store venue preference data into user data area 2122. Manager system 110 running venue preferences process 111 can ascertain preferences as to venues of the various users of system 100. In one embodiment, manager system 110 can extract information on venue preferences of the user by examining location data to ascertain venues visited by users. Manager system 110 can also or alternatively determine information on preferred venues of a user based on rate of acquisition of items from such venues.

Manager system 110 running assembly preferences process 112 can identify composited items associated with a user that are assemblages of component parts. Examples of composited items that are compositions of other items and can be assembled at home span across food, household products, DIY projects, and personal care items. In food preparation, common examples include sandwiches, which consist of bread, meat, cheese, vegetables, and condiments; pizzas, made by layering dough with sauce, cheese, and toppings; and salads, which are created by mixing greens, proteins, dressings, and seasonings. More complex meals like lasagna require layering pasta, sauce, cheese, and filling ingredients, while soups and stews involve combining a broth base with vegetables, proteins, and spices. Similarly, smoothies and parfaits are composed of fruits, yogurt, and granola, demonstrating how various ingredients can be combined to create a final dish. Beyond food, household products can also be assembled from multiple components. For instance, homemade cleaning solutions can be mixed using water, vinegar, baking soda, and essential oils, while DIY candles require wax, wicks, and fragrance oils. In personal care, homemade skincare products such as face masks can be created using honey, oatmeal, and yogurt, while lip balms may be made from beeswax, coconut oil, and shea butter. Homemade hair conditioners often consist of natural ingredients like avocado, banana, and olive oil. DIY projects also involve combining multiple materials to create a functional item. For example, homemade furniture such as a simple wooden shelf requires wood planks, screws, and brackets, while handmade clothing or accessories may be sewn together from fabric, thread, and buttons. Homemade candles or soaps involve melting and mixing base ingredients like wax or glycerin with fragrances and dyes. Even basic home repairs often require assembling parts, such as fixing a leaky faucet with washers, seals, and tools, or constructing a storage organizer using wooden boards and nails. These examples highlight how many household items, foods, and personal care products are composed of multiple elements that individuals can assemble or prepare at home, often allowing for greater customization, cost savings, and sustainability. Manager system 110 running assembly preferences process 112 can ascertain composition assets of users. A composited item of a user herein refers to a physical item of a user that is composed of component parts.

Manager system 110 running association rule process 113 can include manager system 110 ascertaining association rules for a user and/or user groups as set forth herein. Ascertaining an association rule, manager system 110 can run various processes. Generating an association rule involves identifying relationships between items in a dataset based on their co-occurrence. The process starts with frequent itemset mining, typically using the Apriori or FP-Growth algorithm, which finds item combinations that appear together above a predefined support threshold (the percentage of transactions containing an itemset). From these itemsets, association rules are generated by establishing an antecedent (if condition) and a consequent (then condition). Rules are evaluated using confidence (how often the consequent appears when the antecedent occurs) and lift (how much more likely items appear together than independently). Strong rules help in predictions, recommendations, and decision-making across various domains.

Manager system 110 running presentment preferences process 114 can ascertain presentment preferences of a user. For ascertaining presentment preferences of a user, manager system 110 can, e.g., ascertain behavior and/or appearance preferences of a user. For ascertaining behavior preferences of a user, manager system 110 can examine result data of association rule process 113. For ascertaining appearance preferences of a user, manager system 110 can examine posted photographs of a user posted by a user on a social media system defined by an enterprise system of enterprise systems 160A-160Z. In another example, manager system 110 running appearance preferences process 114 can examine data on apparel items acquired by a user.

Manager system 110 running group identification process 115 can identify a group classification for an individual user of system 100. Embodiments herein recognize that in some use cases, user data for a particular user can be sparse, e.g., in the case that the user is a new user. In some embodiments, where a volume of user data available for processing according to one or more of processes 111 to 114 fails to satisfy a threshold volume, manager system 110 can ascertain a group classification for a user and can process group data rather than individual data in the performance of one or more of processes 111 to 114.

Manager system 110 running metaverse generating process 116 can include manager system 110 generating a metaverse for an individual user in dependence on results data resulting from running one or more processes according to processes 111 to 114. Manager system 110 running metaverse generating process 116 can include manager system 110 running a scene composition process 117, can also include manager system 110 running a digital asset population process 118, and can further include manager system 110 running an avatar developing process 119.

Manager system 110 running scene composition process 117 can include manager system 110 generating a scene in dependence on result data resulting from manager system 110 running venue preferences process 111. Manager system 110 running digital asset population process 118 can include manager system 110 populating one or more digital assets into a scene composed by scene composition process 117 in dependence on result data resulting from manager system 110 performing assembly preferences process 112 and/or association rule process 113.

Manager system 110 running avatar developing process 119 can include manager system 110 developing an avatar for placement into a scene composed by scene composition process 117 in dependence on result data resulting from appearance preferences process 114. Manager system 110 running metaverse generating process 116 can include manager system 110 generating a metaverse defining a virtual world as depicted in FIG. 1.

The generating can be performed in dependence on processing of user data according to one or more of processes 111 to 114, which user data, in one embodiment, can be obtained from sensor devices 150A-150Z of sensor system 150, UE devices of UE devices 140A-140Z and/or from enterprise systems of enterprise systems 160A-160Z.

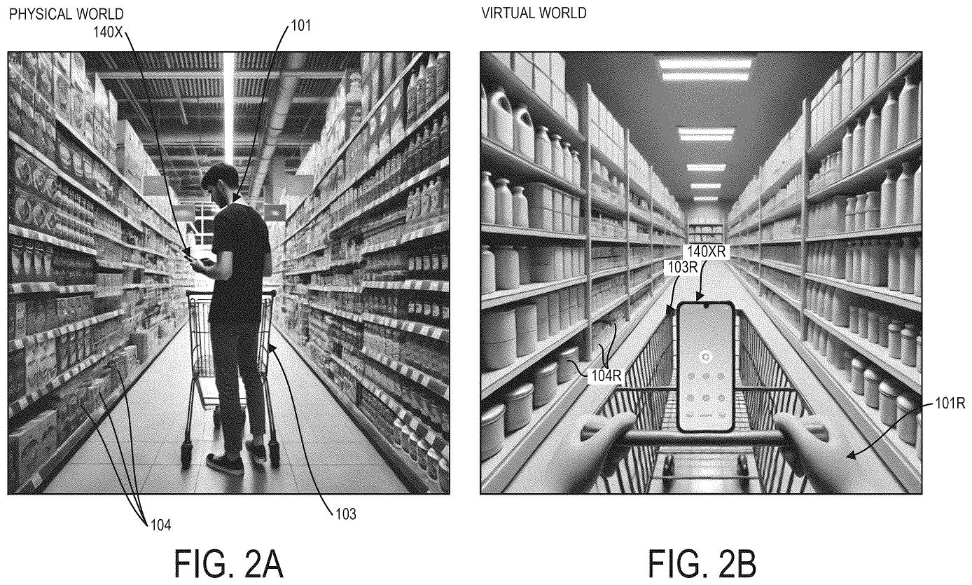

FIGS. 2A and 2B depict further attributes of a physical world and a virtual world defining a metaverse as shown in FIG. 1. User data of a user 101, as depicted in FIG. 2A, can be obtained from sensor devices of sensor devices 150A-150Z of sensor system 150 and/or from enterprise systems of enterprise systems 160A-160Z.

During operation of metaverse generating process 116, there can be generated a metaverse defined by a virtual world as depicted in FIG. 2B. The metaverse of FIG. 2B can include representations of assets of a physical world as shown in FIG. 2B, including, e.g., smartphone representation 140XR of smartphone 140X associated with user 101 as depicted in FIG. 2A, cart representation 103R representing cart 103 of the physical world in FIG. 2A, and item representations 104R representing items 104 in the physical world as shown in FIG. 2A.

In the metaverse depicted in FIG. 2B, there can further be rendered avatar representation 101R of user 101. The generated metaverse defining the virtual world of FIG. 2B can be generated based on historical experiences of user 101 in visiting multiple historical venues over time and/or can be based on historical user data of users of a common user classification with user 101.

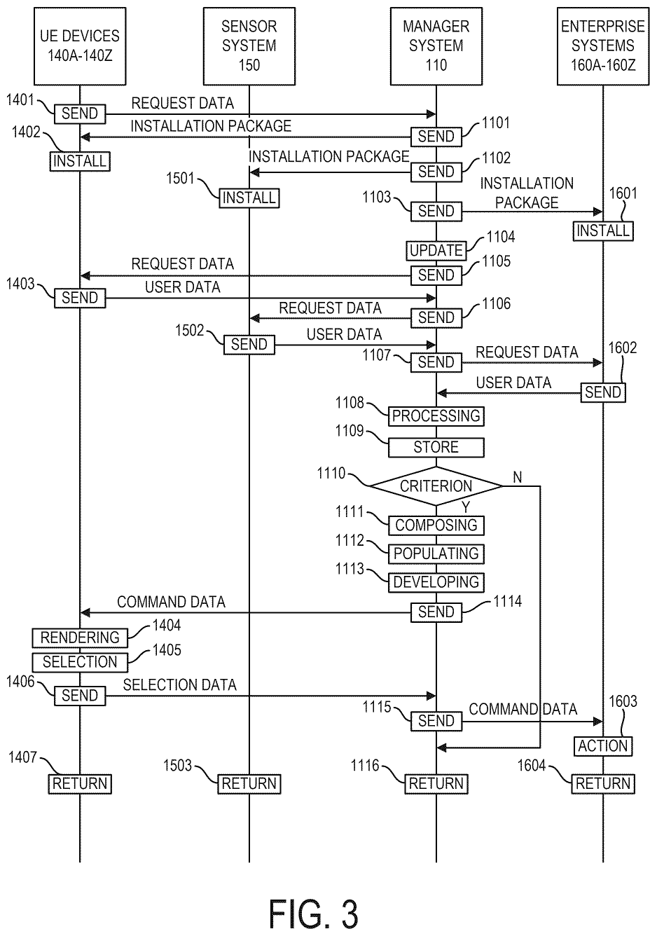

A method for performance by manager system 110 interoperating with UE devices 140A-140Z, sensor system 150, and enterprise systems 160A-160Z is set forth with reference to the flowchart of FIG. 3.

At block 1401, users of UE devices 140A-140Z can be sending request data for receipt by manager system 110 requesting participation in services provided by manager system 110. Services provided by manager system 110 can include generating a custom metaverse for particular users who are registered with manager system 110. The request data sent at block 1401 can include a request to become a registered user and other data such as permissions data, permitting manager system 110 to collect and examine user data from various sources such as UE devices of the requesting user and enterprise systems associated with the user. Request data sent at block 1401 can include, e.g., address data, specifying addresses for access of user data associated with a requesting user, e.g., social media addresses, addresses associated with customer loyalty programs, addresses according to payment portals, and the like, as well as permission data associated with such address data.

In some embodiments, request data sent by a user at block 1401 can include request data from an agent user who is associated with an enterprise, such as an item acquisition enterprise, e.g., a retail store providing access to manager system 110 to, e.g., API endpoints and other resources facilitating collection of user data where permitted by a user associated with a certain enterprise.

In response to the request data sent at block 1401, manager system 110 can proceed to send blocks 1101, 1102, and 1103. At send blocks 1101, 1102, and 1103, manager system 110 can send installation packages respectively to UE devices of requesting users at send block 1101, to sensor system 150 at send block 1102, and to enterprise systems at send block 1103. In response to the installation package sent at block 1101, UE devices of UE devices 140A-140Z can proceed to install block 1402 in order to install the installation package. The installed installation package installed at block 1402 can facilitate participation of a UE device and its associated user in services provided by manager system 110. In one embodiment, the installation package installed at block 1402 can include metaverse rendering software.

Metaverse rendering software incorporates several key features to create immersive, high-fidelity virtual environments that enable real-time interaction. One of the primary features is real-time rendering, which ensures smooth, high-frame-rate visuals optimized for VR and AR experiences. Advanced ray tracing and global illumination techniques enhance lighting realism by simulating shadows, reflections, and light diffusion. Procedural generation allows for dynamic worldbuilding, automatically creating vast environments with intricate details while optimizing performance. Level of detail (LOD) management helps maintain rendering efficiency by adjusting object complexity based on the user's proximity, ensuring that distant objects use fewer resources while maintaining high detail in close-up views.

Another critical feature is physics-based rendering (PBR), which applies realistic materials, textures, and surface interactions by simulating how light interacts with different objects. Avatar rendering and animation systems enable lifelike character representation through motion capture, facial tracking, and AI-driven behaviors, making avatars more expressive and responsive. Multiplayer synchronization ensures seamless real-time interactions between users by synchronizing environments, object states, and user actions across various devices and network conditions.

Cloud-based rendering and edge computing allow high-performance graphics to be streamed to lower-end devices, making the metaverse more accessible. AI-driven asset optimization helps reduce computational load by dynamically adjusting textures, polygons, and effects based on system capabilities. Cross-platform compatibility ensures that metaverse environments are accessible across VR headsets, desktops, mobile devices, and gaming consoles, providing a unified experience. Customization and modding support allow users to create and modify content, adding user-generated assets, environments, and interactive elements. Lastly, blockchain integration is increasingly used for secure asset ownership, ensuring that virtual items, avatars, and NFTs have verifiable authenticity. These features collectively enable a highly interactive, scalable, and visually rich metaverse experience that caters to diverse users and applications.

To render a 3D metaverse environment, a client device can be equipped with client software that includes or integrates a real-time 3D graphics engine, such as Unity® (a registered trademark of Unity Technologies), Unreal Engine® (a registered trademark of Epic Games, Inc.), or web-based engines such as Three.js or Babylon.js, depending on the platform architecture and deployment requirements. This client software can be configured to load and render digital assets provided by a server system, such as manager system 110, including 3D models, textures, shaders, materials, and animations, typically using industry-standard formats like glTF™ (GL Transmission Format), FBX® (a registered trademark of Autodesk, Inc.), or USDZ (developed by Pixar). The rendering framework may support a scene graph or similar hierarchical architecture to organize object relationships, spatial positioning, and update logic, enabling efficient real-time visualization of virtual environments.

An avatar subsystem can be included to render user-controlled or system-defined avatars, optionally supporting skeletal rigs, inverse kinematics, motion blending, and facial expression mapping. The client software may also feature a networking layer to receive structured command data from the server—such as scene definitions, digital asset references, behavioral logic, and avatar states—via communication protocols like WebSockets, HTTP/2, or gRPC® (a registered trademark of The Linux Foundation). Interaction systems may support input from various devices, including keyboards, mice, game controllers, touchscreens, and extended reality (XR) interfaces such as Meta Quest® (a registered trademark of Meta Platforms, Inc.) or HTC VIVE® (a registered trademark of HTC Corporation). To ensure smooth performance across diverse client devices, the software may incorporate optimization features such as level-of-detail (LOD) control, frustum and occlusion culling, and on-demand asset streaming. This flexible and modular client software stack enables responsive and immersive metaverse experiences, driven by server-side logic and dynamically tailored to each user's context, preferences, and device capabilities.

In response to the installation package sent at block 1102, sensor system 150 can install the installation package at block 1501. In response to the installation package sent at block 1103, enterprise systems of enterprise systems 160A-160Z can install the instances of the installation package sent at block 1103. In one aspect, the installation package installed at block 1501 can configure sensor system 150 to return user data of a particular user based on permissions data of the particular user sent at send block 1401.

In one aspect, the installation package installed at block 1601 can include an installation package configuring an enterprise system to return user data of a particular user based on permission data sent by the particular user at send block 1401. In response to completion of send block 1103, manager system 110 can proceed to update block 1104.

At update block 1104, manager system 110 can be updating users area 2121 to include the most recently updated user data specifying all current individual users of system 100 as well as all enterprise system users of manager system 110. At update block 1104, manager system 110 can also be updating enterprises area 2126, and enterprises area 2124, so that enterprises area 2124 specifies all item acquisition enterprises participating in services provided by manager system 110. In enterprises area 2124, there can be included, e.g., API endpoint data enabling the access of user data with permission from enterprise systems of enterprise systems 160A-160Z and also user data permissions from sensor devices of sensor devices 150A-150Z of sensor system 150.

On completion of update block 1104, manager system 110 can proceed to send block 1105. At send block 1105, manager system 110 can be sending request data to UE devices of UE devices 140A-140Z of participating registered users based on request data and permissions data, including permissions data sent by such users at send block 1401. In response to the request data, UE devices of UE devices 140A-140Z can be sending user data to manager system 110. The user data sent at block 1403, based on permissions data sent previously by the user, can include, e.g., smartphone pictures captured by the user on a storage device of the UE device; e.g., smartphone browser data of the user specifying websites visited by the user, also based on permissions of the user; item acquisition payment data of the user, also based on user permissions; live camera video data of the user that specifies current surroundings of the user, also based on permissions of the user; and location data of the user, e.g., as captured by an onboard sensor device of the UE device, e.g., a GPS sensor of a smartphone, and the like.

On completion of send block 1105, manager system 110 can, at send block 1106, send request data requesting the sending of user data from sensor system 150. In response to the request data sent at block 1601, sensor system 150, by participating sensor devices of sensor devices 150A-150Z, can be sending user data. Such user data sent at block 1502 can include, e.g., location data, camera video data that specifies spatial representations of users based on permission data of the user, and the like.

On completion of send block 1106, manager system 110 can proceed to send block 1107. At send block 1107, manager system 110 can be sending request data to enterprise systems of enterprise systems 160A-160Z. In response to the request data sent at block 1107, the enterprise systems of enterprise systems 160A-160Z can be sending, at send block 1602, user data to manager system 110. The user data sent at block 1602 can include, e.g., social media post data of a user based on permissions data of the user, e.g., posted videos and/or still images of the user, text-based messages posted by the user, and other posted data of a user. User data sent at block 1602 can include item acquisition data specifying items acquired by the user, e.g., from an item acquisition venue, e.g., a retail store.

In response to the user data received in response to send blocks 1403, 1502, and 1602, manager system 110 can proceed to processing block 1108. At processing block 1108, manager system 110 can be performing venue preferences process 111, assembly preferences process 112, association rule process 113, and appearance preferences process 114, as set forth in reference to FIG. 1. Also, at processing block 1108, manager system 110 can be performing group identification process 115 to ascertain a user group classification for each registered user for whom user data is processed at processing block 1108.

In some embodiments, manager system 110 can be performing group identification process 115 on a selective basis, i.e., only for select users in dependence on the corpus of available user data for each user. In other words, manager system 110 can avoid identification of a group classification for a particular user where a corpus of user data for the user satisfies a threshold sufficient to enable meaningful result data to be produced by the performance of processes 111 to 114 using only data for the particular user.

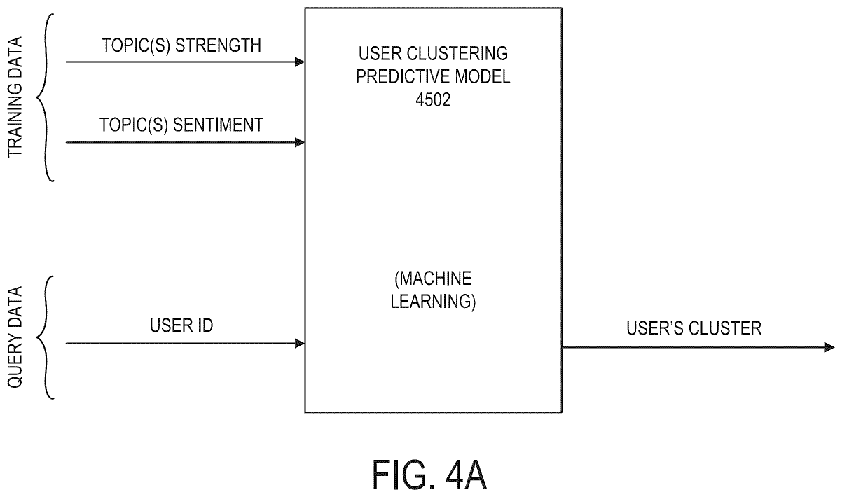

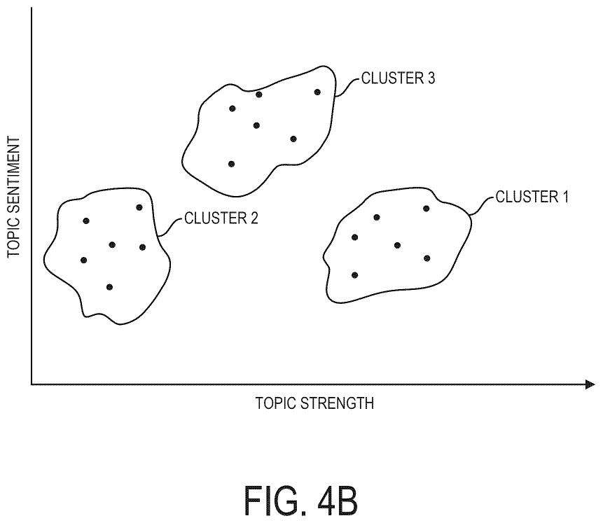

Clustering analysis for use in determining similar users is set forth in reference to FIGS. 4A-4B. Manager system 110 can be establishing a user classification for any user of system 100 by application of clustering analysis as set forth in FIGS. 4A-4B, wherein identified user clusters define user classifications. Over time, manager system 110 can be iteratively updating clustering analysis for clustering and classifying users as set forth in FIGS. 4A-4B. For performing clustering analysis illustrated in FIGS. 4A-4B for identification of common types of users, manager system 110 can be processing text-based documents associated with all users. The text-based assets can include, e.g., social media posts of the various users as acquired from a social media system, as well as other text-based assets of the various users, including text-based assets acquired via acquisition of request data defined by registration data sent at block 1401 and any text-based item reviews posted by users acquired from a social media system, and any text-based assets of a user received responsively to send block 1403, and/or send block 1502, and/or send block 1602. In one use case, registration data defining text-based assets of a user can include survey response data. Manager system 110 can be subjecting all text-based assets of all users to natural language processing by operation of a natural language processing process for extraction of a topic strength of one or more key topics, as well as sentiments associated with such topics.

FIG. 4A depicts a clustering machine learning model 4502 and FIG. 4B depicts functioning of the machine learning model. FIG. 4B depicts plotted dimensional data points for multiple users of system 100 for a designated key topic. For the key topic, manager system 110 can assign a topic strength value and a topic sentiment value. Manager system 110 can apply topic strengths as indicated in FIG. 4B in dependence on the count of times the key topic is extracted per predetermined volume of asset data, e.g., based on a count of topic extractions for every 1,000 words. Manager system 110 can apply a topic sentiment by performing sentiment extraction using natural language processing on text-based content associated with respective key topic extractions.

Manager system 110 can identify clusters of users by their close proximity in Euclidean space, and can assign the clusters various cluster identifiers, e.g., cluster 1, cluster 2, and cluster 3 as depicted in FIG. 4B. Referring to FIG. 4B, manager system 110 can assign sentiment values to users for the key topic depicted on a scale, e.g., of 0.0 to 1.0, with values from 0.0 to 0.5 being negative sentiment values, the value of 0.5 being a neutral sentiment, and the values 0.5 to 1.0 being positive sentiment values. While a single key topic is depicted in FIG. 4B, manager system 110 can expand the clustering analysis across additional dimensions defined by additional key topics.

On completion of processing block 1108, manager system 110 can proceed to store block 1109. At store block 1109, manager system 110 can be storing, in user data area 2122, raw user data for all users for whom user data was sent at the most recent iteration of block 1403, 1502, and block 1602. In another aspect, storing at store block 1109 can include storing results data resulting from processing; i.e., storing in user data area 2122 results data resulting from processing user data at processing block 1108. On completion of store block 1109, manager system 110 can proceed to criterion block.

At criterion block 1110, manager system 110 can ascertain whether criteria for generating a metaverse have been satisfied. In one aspect, user data sent at block 1403 for a particular user can include selection data that specifies that the user would like to enter a customized metaverse. In such an embodiment, the satisfaction of a criterion at criterion block 1110 can include ascertaining that selection data of a user requesting entry into a metaverse has been sent with user data sent at block 1403 for a particular user.

In other use cases, criteria at criterion block 1110 can be satisfied without selection data being received from a user, e.g., manager system 110 can be configured so that a metaverse for a given user is generated automatically without selection data received from a particular user.

On determination at criterion block 1110 that criteria for generating a metaverse for a particular user have been satisfied, manager system 110 can proceed to composing block 1111. At composing block 1111, manager system 110 can compose a scene for the certain user in accordance with scene composing process 117. The scene composition can be customized in dependence on the historical data of the user.

On completion of composing block 1111, manager system 110 can proceed to populating block 1112. At populating block 1112, manager system 110 can populate into the scene composed at block 1111 digital assets in accordance with digital asset populating process 118. The populating can be customized in dependence on the historical data of the user.

On completion of the populating process at block 1112, manager system 110 can proceed to the developing process at block 1113. At developing block 1113, manager system 110 can custom-develop an avatar representing the certain user in accordance with avatar developing process 119. The developing can be customized in dependence on the historical data of the user.

The process of scene composing at block 1111 in the metaverse can be centered around designing and structuring the virtual environment where users interact. This can involve defining the layout, scale, and spatial organization of the world, ensuring it is both visually engaging and functionally immersive. Developers can begin by selecting or generating terrain, landscapes, and architectural elements, using tools such as Unity, Unreal Engine, or proprietary metaverse engines. Procedural generation can be used to create expansive environments with dynamic features such as mountains, rivers, forests, or futuristic cityscapes. Lighting and atmospheric effects can play an important role in setting the mood, employing techniques such as global illumination, ray tracing, and volumetric fog to enhance realism. Physics simulation can be implemented to ensure that gravity, collisions, and object interactions behave naturally, making movement and engagement intuitive. Environmental audio design can contribute to immersion, including ambient sounds, spatial audio for 3D positioning, and interactive sound effects that respond to user actions.

Additionally, interactive objects such as doors, portals, or animated elements can be introduced to enrich the experience. The scene composing phase can also involve performance optimization, where techniques such as level of detail (LOD) management, culling, and texture streaming can be used to maintain smooth rendering across devices. Networked scene synchronization can be established to ensure that when a user moves an object or modifies the environment, others experience the change in real time. Finally, narrative elements and game mechanics can be incorporated, giving the world purpose, objectives, or social interaction hubs, enhancing user engagement. Through this process, a metaverse scene can be created as a cohesive, interactive, and visually compelling environment, ready for digital assets and avatars to be integrated.

The next phase of metaverse creation can be digital asset populating at block 1112, where the virtual environment can be enriched with objects, structures, and interactive elements that enhance immersion. This process can involve 3D modeling, texturing, and importing assets that define the physical and aesthetic aspects of the metaverse. Assets can include buildings, furniture, vehicles, plants, tools, or interactive objects, all of which can contribute to realism and user engagement. These digital objects can be sourced from 3D asset libraries, procedurally generated, or custom-built using software like Blender, Maya, or ZBrush.

To optimize performance, polygon count reduction, baked lighting, and texture compression can be used, ensuring high-quality visuals without straining system resources. Many digital assets can be assigned physics properties, allowing objects to be picked up, thrown, or interacted with in realistic ways. Material shaders and physics-based rendering (PBR) can further enhance immersion by simulating how surfaces react to light, reflections, and environmental conditions like water or wind.

Additionally, non-playable characters (NPCs) or AI-driven entities can populate the world, offering dynamic interactions and enhancing the realism of the environment. These NPCs can function as guides, traders, quest-givers, or social interactors, each programmed with behavioral AI to respond naturally to user actions. Haptic feedback and spatial audio can be used to make interactions with digital objects feel more tangible. Asset placement and navigation can be carefully planned, integrating collision boundaries, wayfinding cues, and accessibility features for better usability. Dynamic asset spawning can introduce interactive elements in real time, such as event-driven objects or user-generated modifications.

Furthermore, blockchain-based digital assets, such as NFTs, can be integrated, allowing users to own, trade, and showcase unique virtual items within the metaverse. By the end of this phase, the digital world can be fully populated with functional, aesthetically compelling, and interactive assets, preparing the environment for avatar integration and user engagement.

For generating a custom metaverse, manager system 110 can be performing avatar developing at block 1113, where users can be provided with digital representations that enable movement, interaction, and social engagement within the virtual world. Avatar development can begin with character modeling and rigging, allowing users to choose from pre-made templates or create custom avatars with unique physical traits, clothing, and accessories.

Advanced avatar creation tools can utilize procedural character generation, AI-driven facial recognition, and morphing algorithms to allow extensive customization, making avatars a reflection of real-world identities or creative expressions. Skeleton rigging and inverse kinematics (IK) can be applied to facilitate natural movement, ensuring that animations adapt realistically based on user input. Facial motion capture and lip-syncing can be used to enhance realism, allowing avatars to express emotions in real time using webcam tracking, neural networks, or specialized VR sensors.

Gesture-based interactions can be incorporated, enabling avatars to wave, point, or use hand signals through motion tracking and hand presence systems. Clothing and accessories can be integrated using physics-based simulations, allowing fabric to react naturally to movement and environmental forces.

In multiplayer metaverse settings, avatar networking synchronization can be beneficial, ensuring that all users see consistent animations and actions in real time, reducing lag and enhancing immersion. AI-driven behavior modeling can be implemented to allow avatars to exhibit autonomous actions, adaptive expressions, and context-aware responses, making them more lifelike. Voice synthesis and voice modulation can be added to enable real-time avatar communication, making conversations more engaging.

Additionally, digital identity verification and blockchain-based customization can be integrated, allowing users to own, trade, and personalize avatar skins, outfits, and accessories as part of their unique digital identity. By the end of this phase, the metaverse can be fully equipped with expressive, interactive, and highly personalized avatars, ensuring that users experience a deep level of immersion and social connectivity in their virtual interactions.

Manager system 110 can be performing one or more of scene composing at block 1111, digital asset populating, or avatar developing for a user at block 1113 in dependence on processing of historical data of the user performed at processing block 1108. In one embodiment, processing of historical data at block 1108 can include processing item acquisition data of a user that specifies transaction data of the user in which a user has acquired an item.

Manager system 110 can employ association rule learning to analyze user behavior, and can use result data resulting from the analyzed user behavior to control avatar behavior. In one embodiment, manager system 110 can be configured so that users have the option to share their social media interactions and online behavior and/or other user data, which can be leveraged to generate personalized avatar behavior recommendations. By identifying patterns in user data, this approach can enhance the realism and adaptability of avatars within the metaverse.

Manager system 110 can utilize association rule learning, an unsupervised machine learning technique, to identify meaningful relationships and recurring patterns within user data. This process enables the system to detect behavior correlations—such as frequently co-occurring actions or preferences—that can inform how digital avatars behave and interact within a metaverse environment.

In one embodiment, association rule learning can be applied specifically to analyze item acquisition behavior of a user. By examining historical item purchases, manager system 110 can infer patterns of co-acquisition and generate item acquisition rules. These rules can be expressed as result data that defines associations between items commonly acquired together. Manager system 110 can use this data to generate a custom metaverse instance tailored to the user's inferred preferences, thereby enhancing personalization and engagement. Additionally, item association patterns can influence avatar behavior within the metaverse, allowing avatars to exhibit user-specific tendencies such as preferences for certain environments, actions, or digital assets.

Manager system 110 can further refine avatar behavior by analyzing a user's social media activity, browsing behavior, and other digital interactions. Through a presented user interface (UI), users may opt to share relevant behavioral data, which can then be leveraged by manager system 110 to generate behavior recommendations. By identifying correlations across multiple sources of data—including item acquisitions and online behaviors—manager system 110 can dynamically adjust avatar actions to align with the user's personality, habits, and preferences, resulting in a more engaging and lifelike metaverse experience.

In some embodiments, manager system 110 can construct a comprehensive behavioral model of a user by aggregating and analyzing social signals, online activity, and interaction history. This model can be used to simulate a digital persona that reflects not only a user's real-world movements and preferences but also subtle traits such as tone, timing, and social tendencies. The system can continuously evolve the simulation in real time, adapting to new behavioral inputs and refining avatar responses to improve realism. As avatars adjust their behavior based on ongoing user interactions, the overall experience becomes more immersive, while computational resources can be more efficiently allocated through behavior prediction and optimization.

In one implementation, manager system 110 can apply association rule learning to transactional datasets. For example, Table A may represent a dataset in which each row corresponds to an individual item acquisition event, and the “Items Acquired” column identifies items acquired together within each transaction. Manager system 110 can process such a dataset at processing block 1108, using data collected from various sources, including enterprise systems that record retail transactions, social media systems, and item acquisition sensor devices located within physical item acquisition venues. These heterogeneous data inputs can be combined to form a robust dataset for extracting association rules that drive avatar behavior modeling and metaverse customization.

TABLE A

| Transaction ID | Items Acquired |
|---|---|
| 1 | Bread, Milk |
| 2 | Bread, Cheese |
| 3 | Bread, Milk, Cheese |
| 4 | Milk, Cheese |
| 5 | Bread, Milk, Cheese |
| 6 | Bread, Cheese |
| 7 | Bread, Milk |
| 8 | Milk, Cheese |
| 9 | Bread, Milk, Cheese |
| 10 | Bread, Milk |

Each transaction within the dataset can provide insight into patterns of item co-acquisition. By leveraging association rule learning, manager system 110 can identify combinations of items that are frequently acquired together, enabling inference of user preferences and guiding the customization of metaverse experiences.

To extract these insights, manager system 110 can apply the Apriori algorithm, a well-known technique in association rule learning. The first step involves identifying frequent itemsets—groups of items that occur together in transactions with a frequency above a predefined support threshold. The support threshold represents the proportion of total transactions in which a given itemset appears. For example, with a dataset of 10 transactions, a support threshold of 40% requires an itemset to appear in at least 4 transactions to be considered frequent.

Once frequent itemsets are identified, manager system 110 can generate association rules based on a confidence threshold, which reflects the conditional probability that, given the acquisition of one item, another associated item is also acquired. For instance, a confidence threshold of 60% implies that when item A is acquired, there is at least a 60% probability that item B is also acquired within the same transaction.

Manager system 110 can apply the support threshold as a filtering mechanism to eliminate infrequent, statistically insignificant item combinations, thereby focusing on patterns that are meaningful and relevant to user behavior. For example, setting a support threshold of 0.05 ensures that only itemsets appearing in at least 5% of all transactions are considered for rule generation. Threshold levels can be dynamically configured depending on the use case, such as personalization depth, domain specificity, or the desired granularity of avatar behavior modeling.

By tuning both the support and confidence thresholds, manager system 110 can optimize the learning process to reduce computational overhead, minimize noise, and ensure that the resulting rules are both statistically robust and contextually relevant. This efficiency directly contributes to more intelligent avatar responses and a more coherent and personalized metaverse environment.

The frequent itemsets identified using this process are exemplified in Table B.

TABLE B

| Itemset | Support |
|---|---|
| Bread | 80% |
| Milk | 70% |
| Cheese | 60% |
| Bread, Milk | 50% |
| Bread, Cheese | 40% |
| Milk, Cheese | 40% |
| Bread, Milk, Cheese | 30% |

Based on the identified frequent itemsets, manager system 110, applying the Apriori algorithm, can generate association rules that quantify the likelihood of a user acquiring a particular item given the presence of another item in the same transaction. These rules help identify directional relationships between items, revealing behavioral patterns such as product affinity or sequential purchasing tendencies.

Each rule generated by manager system 110 can include a confidence value, indicating the conditional probability of co-acquisition, and a support value, reflecting how commonly the itemset appears in the dataset. Together, these metrics allow manager system 110 to prioritize high-impact rules that are both statistically significant and behaviorally relevant for driving metaverse personalization.

Manager system 110 can compile the resulting association rules into a structured output, such as summarized in Table C, which may serve as the basis for further processing—including behavior modeling, avatar customization, and targeted content rendering within a metaverse environment.

TABLE C

Bread → Milk (conf = 63%, sup = 50%)
Milk → Bread (conf = 71%, sup = 50%)
Bread → Cheese (conf = 50%, sup = 40%)
Cheese → Bread (conf = 67%, sup = 40%)
Milk → Cheese (conf = 57%, sup = 40%)
Cheese → Milk (conf = 67%, sup = 40%)
Bread, Milk → Cheese (conf = 60%, sup = 30%)
Bread, Cheese → Milk (conf = 75%, sup = 30%)
Milk, Cheese → Bread (conf = 75%, sup = 30%)

The result data shown in Table C illustrates strong correlations between specific items. For example, if a user acquires bread, there is a 63% confidence level that they will also acquire milk. Likewise, a user who acquires milk has a 57% likelihood of also acquiring cheese. Manager system 110 can utilize this association rule result data—such as that shown in Table C—to drive the generation of a customized metaverse instance.

In generating such an instance, manager system 110 can perform one or more of scene composing at block 1111, digital asset populating at block 1112, or avatar developing at block 1113, in dependence on the output of item association rule learning. In some embodiments, manager system 110 is configured to populate digital assets—such as virtual representations of retail items arranged on shelves—within a composed metaverse scene based on the volume and nature of item references in the association rule set.

At populating block 1112, manager system 110 evaluates the item rule set, which may be generated using algorithms such as Apriori, FP-Growth, or other frequent pattern mining techniques. The system identifies a target set of items to be populated, along with the appropriate placement logic. When the rule set indicates a high number of relevant items—e.g., based on high support and confidence values—manager system 110 increases digital asset density by instantiating additional item entities within available shelf structures. Conversely, if the rule set includes fewer associations or weaker statistical significance, the system reduces the number of populated items to maintain visual clarity and optimize spatial efficiency.

A population module within manager system 110 manages digital asset instantiation by interfacing with the scene graph structure, ensuring that each item is anchored to its designated shelf node using associated transform data and rendering parameters. This ensures that populated digital assets are visually aligned and structurally integrated into the metaverse scene.

In addition to item selection and quantity, manager system 110 can determine the spatial and conditional order of item placement based on the directional logic expressed in the item-associated rules. For instance, where a rule expresses a directional relationship (e.g., A→B), indicating that item B frequently follows acquisition of item A, the system may populate item B in a location that appears downstream from item A in the user's expected navigation path or visual field.

This order-sensitive placement may incorporate factors such as avatar movement prediction, entry orientation into the scene, or predefined planogram configurations. In some embodiments, manager system 110 may use conditional rendering logic—such as deferred instantiation—so that item B is rendered only after item A is acquired, interacted with, or otherwise triggered by the user. This behavior can be implemented using dependency graphs or event-driven logic that link asset instantiation to user state.

Manager system 110 may also use metadata associated with each item—including affinity scores, rule provenance, or categorical tags—to perform behavioral or thematic clustering. In some cases, this clustering may be executed using algorithmic models such as k-means or hierarchical clustering, enabling related items to be grouped and co-located on shelves or other structures. Throughout this process, manager system 110 maintains real-time updates to the scene's internal data structures—including object hierarchies, transform graphs, and rendering queues—ensuring that item population remains synchronized, efficient, and responsive to rule-driven logic.

This rule-informed population strategy enables manager system 110 to deliver contextually relevant and behavior-aware item presentations that not only align with inferred user preferences but also enhance commercial engagement and immersion within the virtual retail environment.

Beyond item population, manager system 110 can apply association rule result data to the broader generation of a customized metaverse experience. In one aspect, behavioral analysis can directly inform avatar personalization and interactivity.

For example, if manager system 110 identifies that users who frequently participate in social activities also tend to modify their avatars more often, it can proactively recommend enhanced customization features—such as expressive animations, accessories, or cosmetic upgrades—that reinforce social engagement. Similarly, users with a consistent history of exploring adventure-themed environments may be guided toward similar metaverse worlds that reflect those interests, thereby increasing session duration and satisfaction.

Moreover, avatars can be dynamically adapted to reflect learned user behavior. This may include adjusting gestures, communication patterns, or interactive tendencies based on historical behavior patterns. By integrating real-time, AI-driven behavioral simulation, avatars can become increasingly natural, fluid, and context—aware-enhancing the sense of realism and strengthening the user's emotional connection to the virtual experience.

Embodiments herein recognize that the integration of association rule learning into metaverse generation introduces significant advantages by enabling highly personalized interactions, intelligent behavior adaptation, and real-time decision-making capabilities. As avatars become increasingly responsive to user preferences and behavioral tendencies, users experience a more seamless, engaging digital environment, while computing resource utilization is optimized. This capability also supports future advances in AI-based virtual identity modeling, enabling avatars to more accurately reflect real-world behavior. Over time, the dynamic adaptability of manager system 110 ensures that the metaverse evolves continuously, enhancing user immersion and fostering deeper interaction.

By applying association rule learning, manager system 110 enables the generation of intelligent, behavior-driven metaverse environments in which avatars and scenes evolve in response to user preferences and historical interactions. This machine learning approach ensures that digital experiences remain contextually relevant, highly personalized, and resource-efficient. Embodiments herein recognize that association rule learning supports predictive behavior modeling that enhances user engagement, interactivity, and immersion across a range of virtual world applications.

Manager system 110 can apply result data derived from item association rule learning to generate a custom instance of a metaverse. In generating such a custom instance, manager system 110 can apply result data from item association machine learning to (a) customize scene composition at block 1111, (b) customize population of digital assets at block 1112, and/or (c) customize avatar development at block 1113. In one embodiment, manager system 110 generates a metaverse instance in dependence on item acquisition data associated with the user.

Regarding (a), manager system 110 can adjust the size and/or shape of a composed scene at block 1111 in dependence on result data resulting from item association learning. In some embodiments, manager system 110 is configured to compose a scene comprising shelving elements, where the quantity and arrangement of those elements are determined by a set of item-associated rules referencing the number of items to be presented in the metaverse retail environment. Upon generation or retrieval of such an item-associated rule set—e.g., in response to a user session, marketing campaign, or virtual store configuration—manager system 110 can analyze metadata for the referenced items, including item quantity, item size, and layout preferences. Based on this analysis, manager system 110 can dynamically determine the number, type, and dimensions of shelving units required to accommodate the target item set.

This process can invoke a shelf composition module that executes layout logic to allocate virtual shelving space proportional to the number of items referenced. For example, when the rule set includes a larger number of items, manager system 110 can increase the number of shelving instances instantiated in the composed scene and/or scale the dimensions (e.g., height, width, depth) of shelving units to maintain visual clarity and adequate spatial accommodation. Conversely, when fewer items are referenced, the system can reduce the number of shelving units or scale them down to improve space efficiency and visual balance within the virtual store. Shelf assets can be retrieved from a digital asset repository and parameterized using transformation logic (e.g., scale vectors or bounding box adjustments). Scene graph structures can be updated to reflect the hierarchical placement and positioning of shelf components. Manager system 110 may also employ constraint-based layout solvers or rule-based engines to ensure proper shelf positioning in accordance with spatial integrity rules, such as aisle spacing or visibility constraints. Semantic labels or tags may be applied to shelves to maintain associations with item categories or rule-based display conditions. Shelves can be instantiated as structured scene nodes with associated transform components, mesh references, and attachment slots for item population. Scene composition at block 1111 may be performed on the server or client side and may include rendering optimizations such as level-of-detail (LOD) management to ensure scalable performance across device types.

Regarding (b), manager system 110 can populate digital assets at block 1112 in dependence on result data generated from item association learning. In some embodiments, manager system 110 is configured to populate digital assets—such as virtual retail items placed on shelves—within the composed metaverse scene at block 1112, based on the number of items referenced in a generated item-associated rule set. At block 1112, manager system 110 can evaluate the rule set—e.g., generated using standard association rule learning algorithms such as Apriori, FP-Growth, or other frequent pattern mining methods—to determine a target item population set and corresponding placement logic.

When the rule set includes a high number of relevant items (e.g., rules with strong support and confidence values), manager system 110 can increase the number of digital assets instantiated at block 1112 by populating additional item entities onto available shelving structures within the scene. Conversely, when the rule set references fewer items, manager system 110 can reduce the number of populated items to streamline the environment and optimize spatial efficiency. During this process, a population module of manager system 110 manages item instantiation by interfacing with the scene graph, anchoring each item asset to the appropriate shelf node using transform data and rendering parameters. This ensures consistency, accuracy, and visual fidelity across populated assets.

At populating block 1112, manager system 110 can determine the spatial and/or conditional order of item population in dependence on sequence logic encoded within item-associated rules. For example, where a rule expresses a relationship of the form A→B—indicating that item B is frequently acquired after item A—manager system 110 may populate item B after item A within the shelving layout, such that item B appears later along the user's anticipated navigation path or viewing direction within the scene. This order-sensitive population logic at block 1112 can be guided by factors including avatar-centric path prediction, the user's scene entry orientation, or predefined planograms. In some embodiments, manager system 110 may employ deferred or conditional rendering logic, wherein item B is not populated as a visible digital asset at block 1112 unless item A has first been acquired, interacted with, or otherwise triggered by the user. Such logic may be implemented using dependency graphs or event-based triggers that link item instantiation decisions to the user's state within the virtual environment.

Additionally, manager system 110 can use metadata associated with each item—such as rule source, affinity scores, or category tags—to determine clustering and grouping behavior, thereby enabling population of thematically or behaviorally related items in proximity on shelves. This clustering may be executed using rule-based logic or unsupervised machine learning models such as k-means, depending on the context and configuration. At block 1112, manager system 110 also maintains synchronization of the scene's internal data structures, including object hierarchies and transformation graphs, to ensure that the dynamic population of digital assets remains consistent, responsive, and visually coherent. This logic allows manager system 110 to deliver contextually relevant, behavior-aware item presentations that enhance both user engagement and commercial effectiveness within the virtual retail environment.

Regarding (c), manager system 110 can restrict the behavior of an avatar associated with a user in dependence on result data generated from item association learning. In some embodiments, manager system 110, during avatar development at block 1113, can constrain or guide avatar behavior based on the structure and confidence of one or more item-associated rules. For example, where a rule of the form A→B meets minimum support and confidence thresholds, manager system 110 can interpret this as a predicted acquisition sequence and impose behavior constraints on the avatar aligned with the predicted outcome.

In an automated mode, manager system 110 can temporarily override avatar autonomy to guide the avatar's actions in accordance with predicted item acquisition behavior. For instance, if the rule set predicts acquisition of item A, manager system 110 can instruct the avatar to autonomously navigate to the shelf location containing item A and execute a predefined acquisition animation, such as a reach-and-grab gesture. These automated avatar movements can be implemented using motion paths, behavior scripts, and animation controllers defined within the composed scene and triggered by rule evaluation at block 1113.

In a restricted-access mode, manager system 110 can limit the avatar's movement into certain regions of the scene unless those regions contain at least one item referenced in the active item-associated rule set. For example, if a given area includes only items not predicted for acquisition, manager system 110 can prevent the avatar from entering that area by enforcing collision barriers, navigation graph restrictions, or access control flags at runtime.

In a movement-limiting mode, manager system 110 can further restrict specific avatar motions—such as reach actions, arm extensions, or gaze direction—so that the avatar cannot interact with or even perceptually engage with shelving structures that contain only non-predicted items. For example, if a shelf segment contains item X that is not referenced in the active rule set, manager system 110 can disable reach gestures toward that segment by modifying the avatar's limb animation controller, resulting in a null or blocked interaction state. These constraints can be enforced using inverse kinematics, animation blending filters, and gesture suppression logic embedded in the avatar control stack.

To preserve naturalism and avoid over-scripting, manager system 110 can allow a degree of limited autonomy for the avatar within rule-approved areas. For example, the avatar may retain freedom to look around, move within permitted regions, or choose among multiple predicted items, which can improve user trust, simulate realistic consumer behavior, and maintain engagement. Manager system 110 can therefore implement rule-dependent behavior shaping that balances automation and autonomy by enabling or disabling control modules based on scene state and user interaction patterns.

Accordingly, avatar developing block 1113 can include logic to (i) initiate system-controlled avatar movements toward predicted item locations, (ii) restrict access to scene regions that do not include predicted items, and (iii) suppress gestures targeting shelf locations not referenced in the rule set. This behavior management logic reinforces the predictive structure derived from item association rules while supporting a natural and immersive user experience, enhancing engagement and optimizing system resource utilization.

In some embodiments, manager system 110, at processing block 1108, can be configured to identify a composited item associated with a user by performing image processing on one or more captured digital images. These images may be obtained from user-uploaded sources such as a smartphone or may be accessed via external systems, including social media platforms or enterprise image archives, as received at block 1403, 1502, and/or block 1602. To determine whether a physical item depicted in the image qualifies as a composited item—i.e., an item composed of multiple constituent sub-items as described in connection with assembly preferences process 112—manager system 110 can analyze the image content using a combination of pattern recognition techniques and rule-based classification logic. In one embodiment, manager system 110 can apply feature extraction methods such as convolutional neural networks (CNNs), scale-invariant feature transform (SIFT), or histogram of oriented gradients (HOG) to detect the visual signatures of recognizable physical sub-items present in the image. The extracted features can then be compared against a decision data structure stored in decision data structures area 2126, such as a decision table, which maps detected items or item combinations to classification outcomes—e.g., “composited item” or “not composited item.”

If the image contains visual indicators of multiple identifiable sub-items—such as slices of bread, lettuce, and deli meat in a sandwich—manager system 110 can match these features against the decision table and apply a composite classification rule to infer the presence of the composited item. For example, the table may encode rules such as “bread+protein+vegetable=sandwich” or “wood planks+brackets+screws=shelf,” and may incorporate fuzzy logic or probability thresholds to account for common variations in assembly. In instances where certain sub-items are not clearly visible—due to occlusion, poor lighting, or limited resolution—manager system 110 may rely on canonical compositions stored in the decision table to infer the missing components. For instance, if an image includes pasta and sauce but omits visible cheese, a partial match may still trigger classification of the item as “lasagna” if the confidence score exceeds a defined threshold.

The pattern recognition methods employed by manager system 110 may include pretrained object detection architectures such as YOLO (You Only Look Once), Faster R-CNN, or semantic segmentation models like U-Net for isolating and labeling relevant image regions. For specialized item types such as food or personal care products, manager system 110 may use classifiers trained on domain-specific datasets, including ingredient libraries, packaging features, or DIY kit component imagery. Additionally, metadata associated with the image—such as hashtags, captions, geolocation, or timestamps—can be processed using natural language processing (NLP) and incorporated into the classification workflow to improve accuracy.

Accordingly, by referencing structured classification data—such as a decision table—and applying advanced pattern recognition algorithms to user-provided or externally sourced images, manager system 110 can determine whether a depicted item is a composited item and, when applicable, identify its constituent components, thereby enriching user profiles and supporting further customization via assembly preferences process 112.

In some embodiments, manager system 110 is further configured to, at populating block 1112, populate a composed scene—previously generated at composing block 1111—to include for rendering one or more constituent items associated with a detected composited item. Such composited items may be identified by the assembly preferences process 112, which analyzes captured user data, such as digital images, to detect the presence of items assembled from multiple parts (e.g., sandwiches, DIY furniture, or skincare kits) and identify the corresponding sub-items. At populating block 1112, manager system 110 can render virtual representations of the constituent items—such as bread, lettuce, and cheese in the case of a sandwich—to present a scene that reflects the user's compositional behavior or preferences.

This constituent-based population process can be performed independently of populating logic based on item association rule learning. In this way, manager system 110 can populate a constituent item even if it fails to meet a support or confidence threshold under association rule logic. For example, if an item like wax is not strongly supported by prior acquisition data but is identified as a component of a composited item such as a DIY candle, the system can include the wax item in the populated scene based solely on its compositional relevance. In alternative embodiments, a hybrid approach can be used, in which the system integrates results from item association rule learning with compositional data from assembly preferences process 112 to refine the overall population strategy. In such cases, the system may first determine candidate items based on association rule analysis, then enhance or augment that list using the identified constituent items of composited items.

In one implementation, manager system 110 can dynamically adjust the support threshold applied to association rule filtering based on compositional relevance. For example, if item X (e.g., coconut oil) has a support value slightly below a defined threshold in the item association rule set, but is also identified as a constituent of a composited item (e.g., homemade lip balm) associated with the user, manager system 110 can increase the effective support weighting of item X. This allows the system to prioritize items that are both statistically significant and compositionally relevant, improving the contextual fidelity of the rendered scene.

Through this dual-source approach, manager system 110 at populating block 1112 can render scenes based on either composited item logic alone or a combined logic that incorporates both item association rule results and compositional analysis. Because avatar behavior restricting is dependent on the items selected and rendered at populating block 1112, it follows that avatar behavior may also be conditioned on items identified through composited item detection. Restricting avatar behavior based on compositional item relevance enables the system to simulate more purposeful and context-aware interactions. For instance, if a user is identified as regularly assembling candles from wax, wicks, and fragrance oils, manager system 110 can guide or constrain the avatar to engage only with these items, optionally unlocking them in sequence to reflect real-world assembly steps. This enhances realism, supports goal-oriented interaction, and filters out unrelated distractions from the environment.

The restriction logic is grounded in user-specific behavior and not arbitrary—it aligns the avatar's available actions with the user's inferred compositional intent, thereby improving authenticity, reducing cognitive load, and optimizing system performance. Accordingly, there is set forth herein a computer-implemented method for generating a personalized metaverse environment for a user, the method comprising: processing historical user data to extract one or more behavioral patterns and preferences; and generating a personalized metaverse environment based on result data derived from that historical data, wherein the generating includes composing a virtual scene, populating that scene with one or more digital assets, and developing an avatar that represents the user, and wherein the developing of the avatar includes restricting one or more behavioral aspects in dependence on (a) result data derived from item association rules identifying predicted acquisition sequences, and (b) result data derived from identifying one or more composited items associated with the user, each composited item comprising a plurality of constituent items. The restricting can include triggering system-controlled movement of the avatar toward a scene region containing a first item referenced as an antecedent in an association rule, animating the avatar to perform a predefined acquisition gesture, enabling access to a second scene region only after acquisition of the antecedent item, limiting gestures or motion paths toward scene areas that do not include either predicted items or compositional items, overriding user-initiated interactions with such areas using alternative animations such as a shrug or redirection gesture, and preserving limited avatar autonomy by allowing exploration within user-relevant regions defined by predicted and compositional items. Additionally, in response to detecting that a user-selected item corresponds to a constituent of a composited item, manager system 110 can visually highlight the remaining sub-items in the scene and unlock additional scene content or avatar behavior linked to the complete composition.

In some embodiments, manager system 110 can perform scene composing at composing block 1111, digital asset populating at populating block 1112, and/or avatar developing at developing block 1113 to generate a metaverse environment that is customized to a specific user based on additional data sources and logic beyond those associated with item association rule learning or composited item identification. For example, manager system 110 can explore social media system data, such as user-generated posts, photos, or profile content, to extract user-specific style, color, and aesthetic preferences. This preference data—identified through natural language processing, image recognition, and clustering algorithms—can be used during scene composing at block 1111 to select decorative elements, color schemes, and lighting styles that reflect the user's personal taste. Similarly, manager system 110 can use such extracted style cues during digital asset populating at block 1112 to determine which items to include or exclude in the scene, such as fashion products, home décor, or brand-specific goods that have appeared in the user's social media history, regardless of whether those items are identified by item association rules or composited item logic. During avatar developing at block 1113, manager system 110 can analyze digital images of the user—such as selfies or tagged photos from social platforms—to generate a photorealistic or stylized avatar that resembles the user, using facial recognition, segmentation, and 3D model fitting techniques. Furthermore, transaction data from Table A can be augmented to include a column referencing the item acquisition venue (e.g., retail store, farmer's market, boutique, etc.) in which a purchase occurred. Manager system 110 can classify these venues by physical characteristics such as size, lighting quality, ceiling height, and décor style, and then analyze the user's historical transactions to determine which venue classification is statistically associated with the highest likelihood of item acquisition. Using this data, manager system 110 can perform scene composing at block 1111 in a manner that replicates the spatial and visual characteristics of the identified venue type—such as simulating the ambiance of a cozy boutique or an industrial-style warehouse—thereby increasing the realism and behavioral resonance of the scene and potentially enhancing the likelihood of user engagement and item interaction. These methods allow manager system 110 to generate highly personalized and immersive metaverse experiences that reflect a broader understanding of the user's behavior, style, and environmental context.

In some embodiments, manager system 110 can be configured to perform training and querying of a neural network predictive model to support preference-based personalization. During a training phase, manager system 110 can collect and preprocess user data, which can include interaction histories, purchase records, demographic attributes, social media activity, and survey responses. These data points can be encoded as feature vectors and labeled with corresponding outcomes, such as item selections, category interests, or scene interaction patterns. Manager system 110 can use this labeled dataset to train a neural network model—such as a feedforward neural network, recurrent neural network, or transformer model—by adjusting model parameters to minimize prediction error through backpropagation and gradient descent. Once trained, the model can be stored and made available for inference operations. During querying, manager system 110 can input new or partial user data—such as data from a current session, recent interactions, or inferred cluster membership—into the trained model to generate predicted preferences. These predicted preferences can then be used during composing at block 1111, populating at block 1112, or avatar developing at block 1113 to tailor the generated metaverse environment to the user. The training and querying operations can be performed on a recurring basis to reflect updated user data over time.

In some embodiments, manager system 110 can initiate an initial evaluation process at processing block 1108 to determine whether a sufficient quantity and diversity of user-specific data is available to support the generation of a personalized metaverse experience tailored to a particular user. This evaluation may begin with a comprehensive analysis of all digital data assets associated with the user, which may include, but are not limited to, image data, interaction logs, purchase or item acquisition history, social media posts, registration form responses, in-app behavioral data, and other digital traces that reflect the user's preferences, behaviors, and engagement history.

At processing block 1108, manager system 110 can apply a sufficiency thresholding technique designed to evaluate whether the collected user-specific data meets or exceeds a predefined threshold. This threshold may be based on one or more quantitative and/or qualitative metrics, such as the total number of unique data points, word count across user-generated text, number of distinct transactions, diversity of content types, or the presence of semantically rich metadata. The sufficiency threshold may be empirically determined to ensure that downstream personalization processes—such as scene composition, digital asset population, and avatar customization—are adequately informed by meaningful user-specific inputs.

If the volume or richness of the available user-specific data fails to meet the predefined sufficiency threshold, manager system 110 can transition from a direct personalization mode—in which metaverse customization features are derived directly from the data of the specific user for whom the metaverse is being generated—to a generalized personalization mode. In this fallback mode, the system can utilize surrogate data derived from user classification data previously generated via clustering analysis, such as that described in reference to FIGS. 4A-4B.

In this generalized mode, manager system 110 can identify one or more user clusters to which the target user belongs, based on prior clustering computations performed using machine learning model 4502. The clustering process may involve the ingestion and analysis of text-based digital assets—including social media posts, registration inputs provided at block 2301, survey responses, product reviews, and other user-submitted documents. Machine learning model 4502 may apply natural language processing (NLP) techniques to extract key topical features and associated sentiment metrics from such text sources. These extracted features may be normalized by standardized metrics (e.g., frequency and sentiment score per 1000 words) and used to map the user into a multidimensional Euclidean feature space.

Within this feature space, manager system 110 can group users into distinct clusters (e.g., Cluster 1, Cluster 2, Cluster 3), each representing a cohort of users with similar preferences, behavioral tendencies, emotional inclinations, or inferred needs. The system can then assign the target user to one or more of these clusters based on their proximity to other users within this space.

Based on the user's cluster assignment(s), manager system 110 can construct a metaverse environment by incorporating representative features, assets, and configurations that are statistically associated with that cluster's collective characteristics. This enables the system to provide a meaningful degree of personalization even in the absence of extensive individualized data for the target user.

In some embodiments, the metaverse generation process may leverage a hybrid personalization approach, in which manager system 110 utilizes both direct and generalized personalization modes concurrently. For example, the system may identify a first set of customization features for the generated metaverse—such as visual scenes, interactive assets, or avatar characteristics—based directly on user-specific data. Simultaneously, the system may identify a second set of customization features based on aggregated data from users within the same user classification or cluster, which may optionally include some overlapping data from the target user.

To further refine the personalization process, manager system 110 can apply the described sufficiency thresholding technique on a feature-by-feature basis, thereby enabling selective incorporation of direct or generalized data sources depending on the sufficiency of information available for each specific customization dimension.

Upon completion of developing block 1113, manager system 110 can proceed to send block 1114. At send block 1114, manager system 110 can transmit command data to the UE device of the certain user, triggering the evaluation of criterion block 1110. Upon receipt of this command data, the user's UE device—configured with the installed package as described in block 1402—can initiate rendering of the metaverse environment generated through blocks 1111 to 1113, in accordance with the instructions specified in the command data sent at block 1114.

The command data sent at block 1114 can include a structured scene description defining the state and arrangement of the metaverse environment composed by manager system 110. This data may include a scene graph or spatial map describing the positions, relationships, and attributes of virtual entities such as shelving units, digital items, avatars, lighting configurations, and environmental boundaries. Additionally, references to required digital asset files—such as 3D models, texture maps, animations, and audio cues—can be provided along with avatar state data, including mesh information, animation controllers, skinning parameters, and behavioral directives. The command data may also embed scene logic derived from earlier processes, including behavioral constraints, item interaction rules, and conditional rendering operations informed by item association rule learning and composited item analysis.

To render the metaverse, the UE device executes a metaverse client application capable of parsing the scene description and performing real-time rendering using a graphics engine such as Unity®, Unreal Engine®, or a custom WebGL-based platform. The client application may also support key rendering and simulation features including asset streaming, scene graph instantiation, avatar animation control, physics simulation, and behavior synchronization based on server-defined rules. Local rendering optimizations—such as level-of-detail (LOD) scaling, frustum culling, and occlusion handling—can be employed to adapt the rendering workload to the performance profile of the client device. In some embodiments, command data sent at block 1114 is formatted using a compact binary serialization schema such as glTF™, Protocol Buffers, or a custom JSON-based schema to reduce bandwidth consumption and minimize latency. This pipeline enables efficient offloading of resource-intensive composition and decision-making logic to the server, while supporting responsive, high-fidelity metaverse rendering across a broad spectrum of client platforms, including desktop, mobile, and extended reality (XR) devices.

Upon completion of rendering at block 1404, the certain user can begin interacting with the generated metaverse. At block 1405, the user may perform a selection action within the virtual environment, such as selecting an item for acquisition. This selection may involve the user directing their avatar within the scene—e.g., moving avatar 101R to interact with a rendered item 104R—and indicating acquisition by placing the item into virtual cart 103R, as depicted in the metaverse scene view of FIG. 2B.

Following completion of selection block 1405, the user's UE device can proceed to send block 1406. At send block 1406, the UE device transmits selection data corresponding to the in-metaverse item interaction performed at block 1405. The selection data may include metadata identifying the selected item, the user's avatar ID, scene context, and an interaction timestamp. In one example, the user may virtually “purchase” an item by moving their avatar to the item and depositing it into a virtual cart, and the system registers this as a selection intent transmitted in the selection data.

Upon receipt of the selection data sent at block 1406, manager system 110 can proceed to send block 1115. At send block 1115, manager system 110 transmits command data to one or more relevant enterprise systems of enterprise systems 160A-160Z. The command data may include instructions to a payment enterprise system to initiate a transaction corresponding to the selected item and may include further instructions to a distribution center enterprise to initiate fulfillment and delivery of the item selected at block 1405.

Upon receipt of the command data sent at block 1115, the receiving enterprise system of enterprise systems 160A-160Z—such as a distribution center enterprise system—can proceed to action block 1603. At action block 1603, the distribution enterprise can dispatch an autonomous robot to retrieve the selected item from its physical location within the distribution center. The robot can be instructed to identify and acquire the physical version of the selected item—based on SKU, shelf coordinates, dimensions, or handling requirements—then pack and load the item onto an autonomous delivery vehicle. This vehicle also at action block 1603 can then initiate travel to a physical address associated with the user who triggered criterion block 1110, such as a residential delivery address.

In some embodiments, the system defined by manager system 110, in reference to blocks 1115 and 1603, can generate command data to coordinate both robotic retrieval and vehicle-based delivery operations. This command data can include low-level instructions compatible with the automation infrastructure of the distribution center. For example, robotic pick-and-place tasks may be issued using Robot Operating System (ROS®)-based control logic, including arm motion sequences, path planning, barcode verification, and error-handling protocols. Once the item is retrieved, manager system 110 can generate vehicle routing data using GPS-based navigation and traffic-aware constraints, integrating with mapping APIs or on-vehicle SLAM (Simultaneous Localization and Mapping) systems to ensure accurate navigation. The vehicle's route may include detailed waypoints, stop logic, and dynamic rerouting capabilities.

Further, manager system 110 can define post-routing directives such as delivery authentication procedures, secure access instructions (e.g., digital locker or compartment unlock codes), robotic drop-off arm deployment, and delivery confirmation signals, such as sensor checks or image capture. All robotic and vehicular instructions may be transmitted using a protocol compatible with the distribution enterprise's automation environment, such as MQTT, gRPC®, or a proprietary message queue.

This end-to-end, server-orchestrated fulfillment process—originating from a metaverse-based user interaction—enables seamless integration between virtual item selection and real-world logistics. Manager system 110 thereby supports intelligent, automated, and scalable fulfillment workflows driven directly by immersive metaverse experiences.

On completion of send block 1115, manager system 110 can proceed to return block 1116. Manager system 110 may alternatively proceed to return block 1116 upon a determination at criterion block 1110 that the criterion for generating a metaverse is not satisfied. At return block 1116, manager system 110 can return to a stage preceding block 1101. Manager system 110 can iteratively perform the loop defined by blocks 1101 through 1116 during an ongoing deployment period.

Similarly, on completion of send block 1406, UE devices 140A-140Z can proceed to return block 1407, returning to a stage preceding block 1401. These UE devices can iteratively perform the loop of blocks 1401 through 1407 throughout their deployment period. In parallel, sensor system 150, on completion of send block 1502, can proceed to return block 1503 and return to a stage preceding install block 1501. This enables sensor system 150 to operate continuously within the loop of blocks 1501 through 1503. Likewise, enterprise systems 160A-160Z can, on completion of action block 1603, proceed to return block 1604, returning to a stage preceding install block 1601, and can iteratively execute the loop spanning blocks 1601 through 1604 during their deployment lifecycle.

Embodiments herein can support an intelligent onboarding process wherein a user is introduced to the system via a discovery phase that evaluates both explicit user preferences and implicit behavioral cues. This process enables manager system 110 to match the user to a metaverse environment that is most aligned with their interests. Relevant metaverse experiences—spanning people, services, spaces, and digital items—can be surfaced dynamically to maximize relevance, engagement, and fulfillment. Through personalized recommendations, users are directed to experiences likely to resonate with them, fostering an interactive and satisfying entry into the metaverse.

Embodiments further provide mechanisms for tailoring the onboarding experience itself. The system can present each user with a unique boarding pathway optimized to enhance targeting and alignment within the metaverse ecosystem. Matching logic can incorporate behavioral data, interest clusters, and user identity signals to determine onboarding content and presentation style. The onboarding flow may optionally include a “window” interface providing an overview of the metaverse, its mechanics, and the user's options. This window may support dynamic features—such as animations or responsive layouts—and can be minimized or expanded interactively.

Customization features also extend to avatar creation and behavior modeling. Users can be offered both randomization and customization options for avatar appearance, including skin tone, facial structure, clothing, and accessories. In one embodiment, a default avatar is generated based on a user's social media profile picture (with consent), enabling a close approximation between real-world and metaverse identity. The system may support privacy and visibility controls for avatars, allowing users to toggle between “ideal self,” “fantasy self,” or anonymous representations.

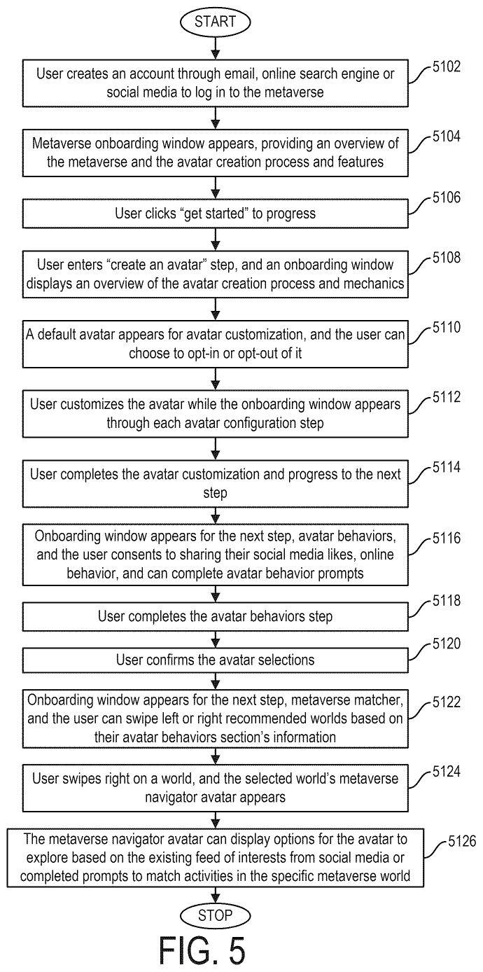

Referring to FIG. 5, a method for performance by system 100 is illustrated for onboarding a user into a personalized metaverse environment. At block 5102, a user can initiate their metaverse journey by creating an account using email, a Google login, or a social media account. Following account creation, at block 5104, the user is presented with an onboarding window introducing the metaverse environment, which provides an overview and step-by-step guidance through the avatar creation process.

At block 5106, the user selects a “Get Started” control to proceed. At block 5108, the system transitions the user into the avatar creation phase, where another onboarding window appears to explain interaction mechanics, such as head-tracking, controller input, or gesture recognition. At block 5110, the system presents a default avatar, which the user can then customize at block 5112. Throughout this process, onboarding prompts appear to assist the user in personalizing the avatar's features, attire, and style. Upon completing avatar customization at block 5114, the user advances to the avatar behavior stage.

At block 5116, the system presents an onboarding window describing avatar behaviors, including behavioral modeling and interaction patterns. The user may, at this stage, opt to grant consent to share their social media preferences, search history, or other digital behaviors. With this consent, the system can configure a digital simulation that enables the avatar to reflect the user's tendencies in gestures, speech, and interactions. At block 5118, the user completes the avatar behavior configuration. At block 5120, the user confirms their avatar selections.

Next, at block 5122, the user is presented with a metaverse world matcher interface—an onboarding window that displays recommended worlds generated based on the user's avatar behavior profile. At block 5124, the user selects a metaverse world by swiping right on a preferred recommendation (or left to skip). Upon selection, the system transports the user into the selected world. At block 5126, a Metaverse Navigator avatar appears in the selected world to welcome the user and guide them. A small overlay window provides an overview of the world and recommends interactive activities tailored to the avatar's configured behavioral profile.

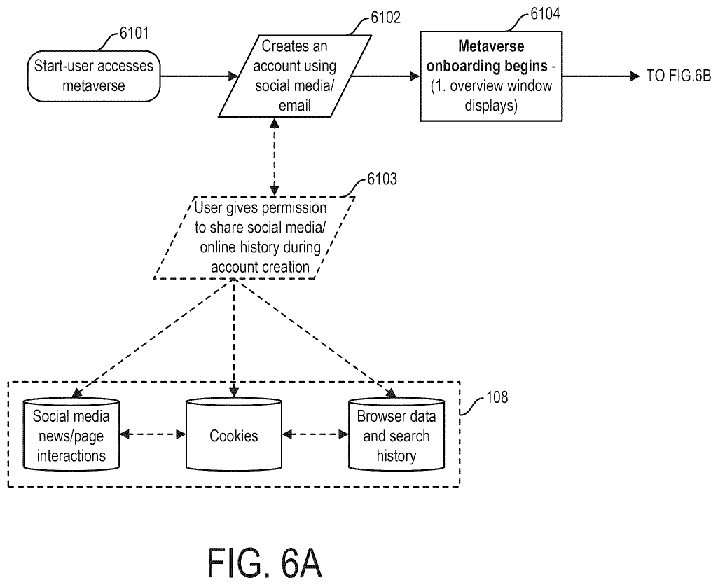

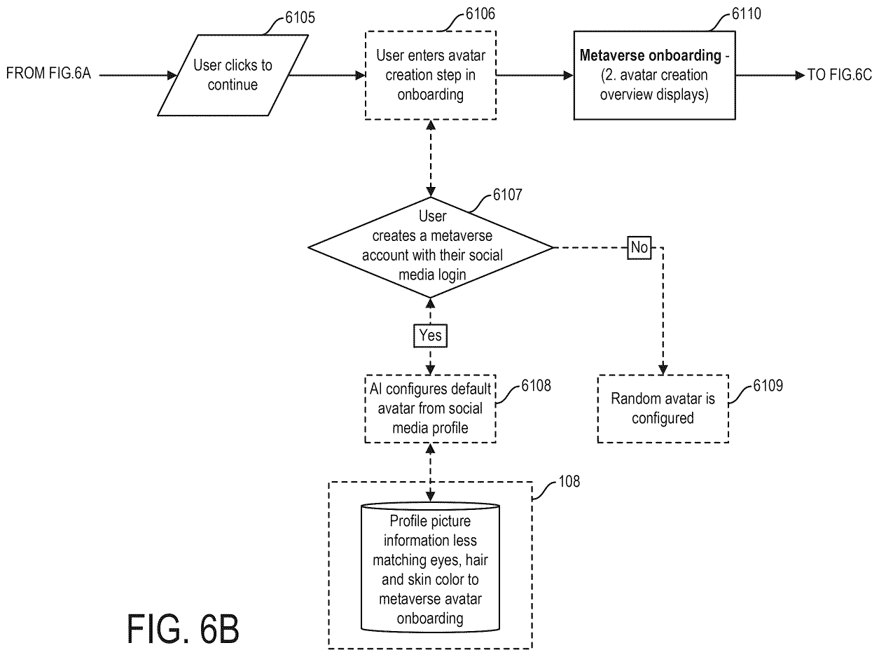

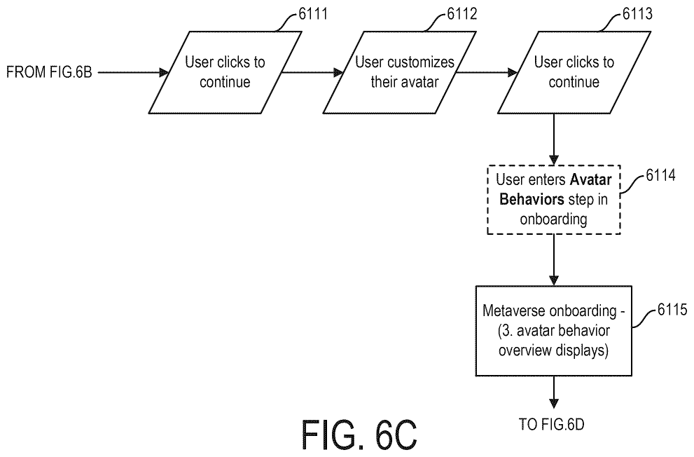

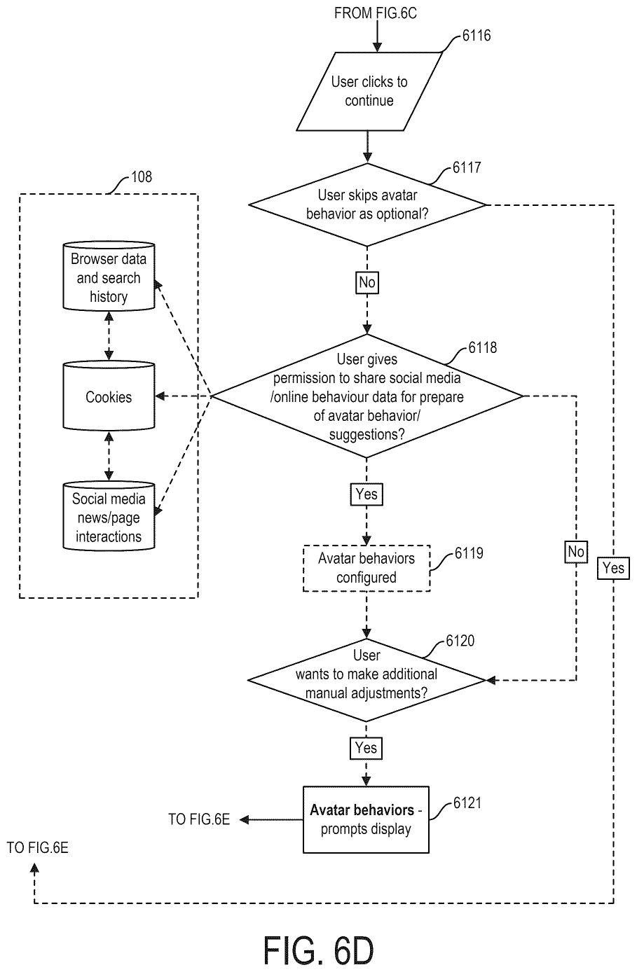

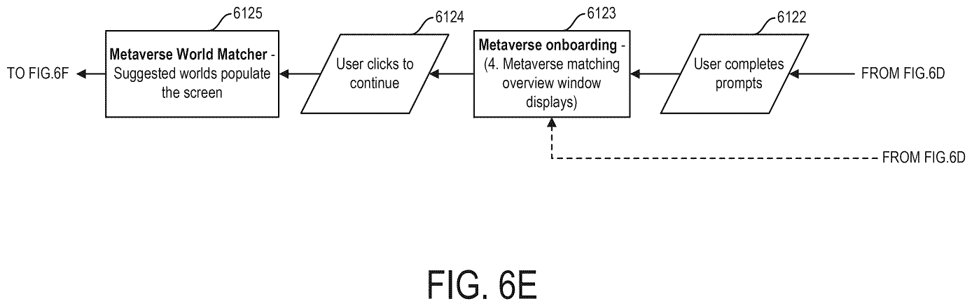

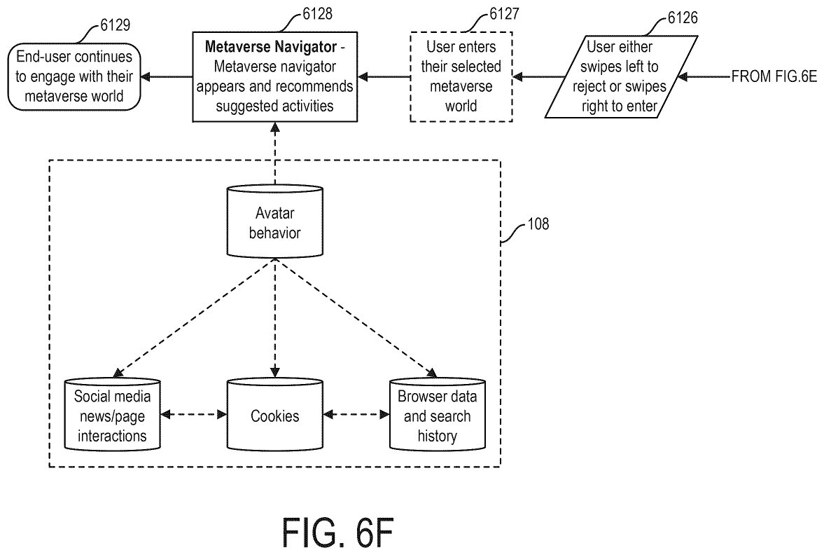

Referring now to FIGS. 6A-6B, a further method for performance by system 100 is shown. At block 6101, a user can access a metaverse user interface. At block 6102, the user may create an account using a social media account or email. At block 6104, the metaverse onboarding process begins. In parallel, at block 6103, the user may be prompted to grant permission for sharing user data to enable further personalization.

At block 6105, the user selects a continue control, which advances the flow to the avatar creation process at block 6106. At block 6110, the system presents an onboarding overlay to guide avatar configuration. At block 6107, the user is given the option to create their avatar using a social media login. If the user chooses yes, the system proceeds to block 6108, wherein a default avatar is generated based on the user's social media profile image. If the user declines, the system proceeds to block 6109, where a randomized avatar is generated.

At block 6111, the user continues to the customization phase. At block 6112, the user personalizes their avatar's features, and at block 6113, selects a continue control. At block 6114, the system presents an onboarding interface to configure avatar behavior. At block 6115, the behavior onboarding logic executes, analyzing user interaction preferences. At block 6116, the user proceeds further into the behavior configuration interface.

At block 6117, the user is presented with a decision point—whether to skip avatar behavior configuration. If the user opts in, they may again be prompted to share social media or online behavior data. If so, at block 6119, the system configures avatar behaviors in accordance with behavioral data, and proceeds to decision block 6120. At block 6120, the user determines whether further adjustments are desired. A “no” response at block 6118 also proceeds to block 6120.

At block 6121, the system may present prompts to guide avatar behavior refinement. At block 6122, the user completes behavioral prompts, and at block 6123, additional onboarding is performed. At block 6124, the user selects a continue control.

At block 6125, the system executes the metaverse world matching process based on the configured avatar and behavior data. The user is presented with world suggestions, and at block 6126, can swipe left to reject or swipe right to enter a recommended metaverse. Once the user confirms entry, at block 6127, they are placed into their selected metaverse environment.

At block 6128, a metaverse navigator avatar appears, offering activity suggestions tailored to the user's preferences and behavior model. Finally, at block 6129, the user begins to interact and engage with the immersive metaverse environment.

Throughout these onboarding and engagement phases, system 100 employs association rule learning to enhance avatar behavior. Users may opt to share their social media activity and online behavior, allowing the system to detect meaningful patterns in the data. These insights are used to generate personalized behavior recommendations for avatars, improving realism, responsiveness, and alignment with user intent.

Association rule learning, an unsupervised machine learning technique, enables the system to identify frequent co-occurring behaviors within user datasets. By learning which behaviors tend to occur together, the system can infer behavioral patterns that are likely to apply to a particular user. This approach allows for the refinement of avatar behavior models based on recognized correlations between past user interactions.

For illustrative purposes, association rule learning is akin to market basket analysis in retail. Just as businesses identify which grocery items are often purchased together to optimize product placement, system 100 can detect which avatar actions or interaction patterns frequently occur together in user data, allowing for better personalization of metaverse behavior and activity recommendations.

In the context of system 100, these learned associations enable the generation of behaviorally intelligent avatars. For example, if a user who engages in virtual fitness classes is also likely to interact with music-related environments, the system may recommend relevant scenes or guide the avatar toward those environments. Association rule learning thus directly enhances immersion and continuity in the user's experience.

Embodiments herein apply association rule learning to model avatar behavior dynamically. By analyzing interactions, preferences, and activity data across multiple users, the system can construct adaptive behavior profiles that evolve in real time. Users who opt in to share social or behavioral data empower the system to generate simulations of personality, movement, and communication styles. These avatars can adapt to changing user behavior, learning from input and environmental responses. As a result, avatars become more natural and expressive, improving the user's emotional engagement and satisfaction within the metaverse. This ongoing personalization contributes to a more immersive, responsive, and intelligent virtual environment.

Various available tools, libraries, and/or services can be utilized for implementation of trained predictive models herein trained by machine learning. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Trained predictive models herein can employ use, e.g., of artificial neural networks (ANNs) support vector machines (SVM), Bayesian networks, and/or other machine learning technologies.

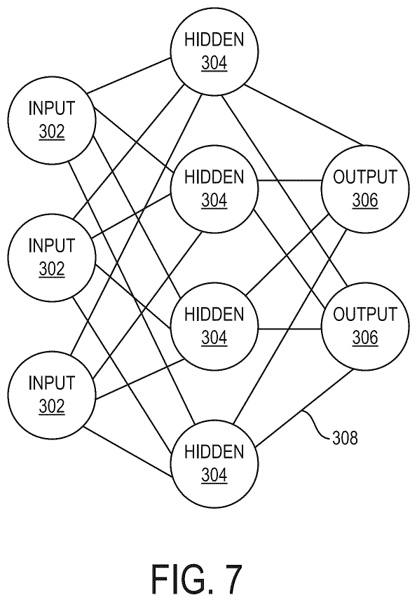

FIG. 7 is an illustration of an example ANN architecture for trained predictive models herein trained by machine learning, such as a predictive model for predicting user preferences.

One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN can be configured for a specific application, such as applications herein.

Referring now to FIG. 7, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Weighted connections 308 between the input neurons 302 and hidden neurons 304 are weighted, and these weighted inputs are then processed by the hidden neurons 304 according to some function in the hidden neurons 304. There can be any number of layers of hidden neurons 304, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output, which can be referring to as outcome training data as referenced in connection with predictive models herein. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process can continue until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be beneficial, or hyperparameters of the ANN may benefit from adjustment.

ANNs may be implemented in software, hardware, or a combination of the two. For example, weights of weighted connections 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, weights of weighted connections 308 may be implemented as resistive processing units (RPUs), generating a predictable current output when an input voltage is applied in accordance with a settable resistance.

Certain embodiments herein may offer various technical computing advantages to address problems arising in the realm of computer systems. A fundamental aspect of computer system operation is its interoperation with human actors. By increasing the accuracy and reliability of information presented to users, embodiments herein enhance user engagement and, thereby, system performance. Customizing a metaverse in dependence on a user's historical data introduces a computationally efficient paradigm that improves both system optimization and user experience. By restricting avatar behavior based on prior user interactions, the system can reduce unnecessary computation by pre-loading only relevant behavioral models, animations, and environmental interactions—minimizing processing overhead and bandwidth usage. Rather than dynamically calculating every possible action in an unrestricted environment, the system employs predictive modeling and behavior constraints to selectively render avatar movements, dialogue options, and engagement triggers. This reduces the number of active processing threads required for real-time simulation and enables adaptive resource allocation. By applying association rule mining techniques, such as the Apriori algorithm or FP-Growth, the system can detect high-probability action sequences and anticipate decisions before they occur—reducing redundant computations by prioritizing likely interactions and deprioritizing low-probability pathways, resulting in lower CPU cycles and memory usage. Rule-based behavior analysis further supports intelligent prefetching and caching, where predicted assets, textures, and animations are preloaded to eliminate rendering lag and improve frame rates. These computing efficiencies are amplified by high user engagement within a personalized, behavior-aware metaverse environment, where tailored content leads to longer sessions, improved data fidelity, and more efficient real-time processing. Higher engagement supports optimized server load balancing, as users interact more predictably with predefined assets rather than generating computationally expensive, unstructured behavior. Adaptive AI-driven environments can reduce the need for real-time world-state recalculations by shifting to incremental updates based on learned behavior clusters, transforming the metaverse runtime engine from an open-ended brute-force simulation into a targeted, self-optimizing framework. In one aspect, the optimized user interface (UI)—of the type presented to users by manager system 110 in conjunction with customized metaverse functionality—serves as a real-time computing resource economizer. By guiding user attention through visual hierarchies, animated cues, and behavior-predictive prompts, the system can focus rendering and interaction resources on high-relevance regions while reducing detail or update frequency for peripheral content using level of detail (LOD) management, culling, and dynamic loading. When user engagement is low, the system must simulate broad, open-ended behaviors, triggering compute-intensive fallback operations such as randomized pathfinding, unscripted object interactions, speculative asset loading, and high-frequency polling of input events. These conditions require increased CPU/GPU load, redundant state checks, and backend logic execution. In contrast, an attention-directing UI reduces exploratory and inefficient behavior—minimizing random movement, excessive object inspection, and interface toggling—and channels user activity toward predictable paths. This allows the system to throttle updates for inactive zones, skip unnecessary animation cycles, and maintain optimal performance even on lower-power devices. Backend systems benefit from more predictable event streams, enabling optimized physics resolution, simplified navigation graphs, and deferred processing for non-engaged regions. The UI thus acts as both an engagement interface and a backend optimization layer—tightening the link between user focus and runtime resource allocation. The synergy between behavior-based avatar restriction, predictive modeling, association rule insights, and UI-driven guidance yields a scalable, responsive, and computationally sustainable framework capable of delivering high visual fidelity and low latency while minimizing energy, memory, and bandwidth consumption across both client devices and distributed cloud systems. Embodiments herein may also incorporate computational platforms such as AI and machine learning systems, featuring improved processes for transforming unstructured data into structured forms suitable for decision-making. These may include processing diverse data inputs such as location data derived from radio signals, social media assets, or sensor-based user behavior, all structured into decision-ready formats. Embodiments can implement specialized arrangements for populating, updating, and using data repositories to drive adaptive AI-based logic. Implementation may occur within various cloud-based platforms, including Software-as-a-Service (SaaS), Platform-as-a-Service (PaaS), or Database-as-a-Service (DBaaS) environments, depending on subscription and deployment configurations.

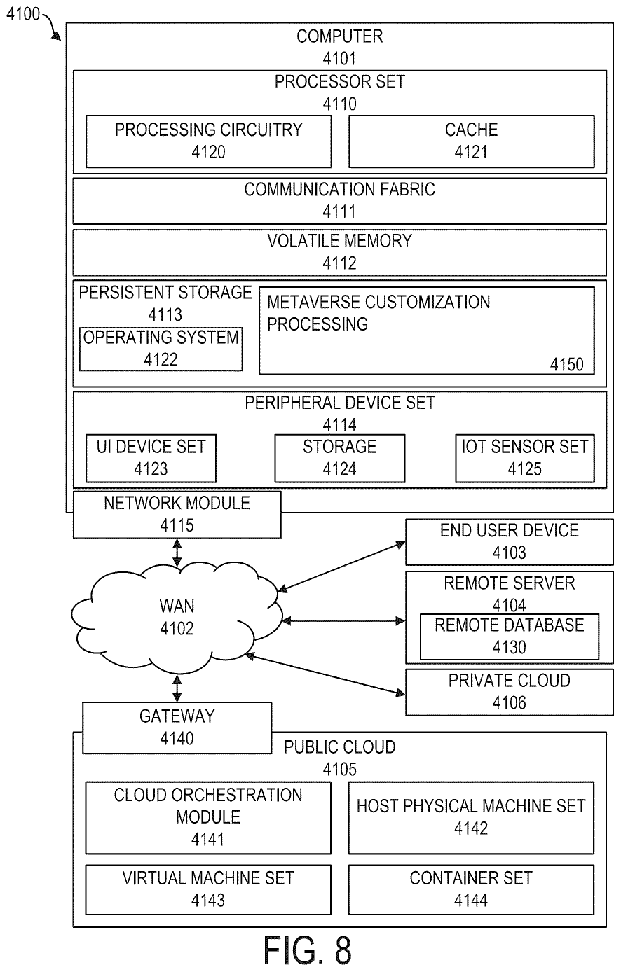

In reference to FIG. 8 there is set forth a description of a computing environment 4100 that can include one or more computer 4101. In one example, a computing node as set forth herein can be provided in accordance with computer 4101 as set forth in FIG. 8.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Hash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 8. In one aspect, a computing environment 4100 contains an example of an environment for the execution of at least some of the computer code involved in performing the inventive methods, such as code 4150 for performing metaverse customization processing as described with reference to FIGS. 1-7. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
processing historical user data;
generating a custom metaverse for a certain user in dependence on the processing, wherein the generating comprises:
composing a virtual scene;
populating the virtual scene with digital assets; and
developing a user avatar that represents the certain user;
wherein one or more of the composing, populating, or developing is performed in dependence on result data resulting from the processing historical user data.

2. The computer implemented method of claim 1, wherein the historical user data includes user data of the certain user.

3. The computer implemented method of claim 1, wherein the historical user data includes user data of the certain user and user data of other users of a common user classification with the certain user.

4. The computer implemented method of claim 1, wherein the result data resulting from the processing historical user data includes defined by item association rules, and wherein the developing the user avatar that represents the certain user includes restricting behavior of the user avatar in dependence on the item association rules.

5. The computer implemented method of claim 1, wherein the result data resulting from the processing historical user data includes defined by item association rules, and wherein the developing the user avatar that represents the certain user includes restricting behavior of the user avatar in dependence on the item association rules, and wherein the populating includes populating digital assets representing items referenced in the item association rules.

6. The method of claim 1, wherein the developing of the avatar comprises restricting one or more aspects of avatar behavior of the user avatar in dependence on result data derived from a set of item association rules indicating a predicted acquisition sequence of items; and wherein the restricting comprises:
(i) triggering system-controlled movement of the user avatar to a scene region containing a first item referenced as an antecedent in an item association rule and performing a predefined acquisition animation;
(ii) enabling access to a second scene region containing a consequent item only after the antecedent item has been acquired; and
(iii) limiting avatar gestures or locomotion directed toward scene areas that do not contain predicted items,
wherein the avatar developing is performed in dependence on the processing historical data.

7. The computer implemented method of claim 1, wherein processing the historical user data includes analyzing camera image data to detect a composited article, and wherein the populating the virtual scene with digital assets includes populating the virtual scene with a constituent item of the composited article.

8. The computer implemented method of claim 1, comprising performing a clustering analysis on the historical user data to determine a group classification for the user, and wherein at least one of the composing, populating, or developing is further performed based on the group classification.

9. The method of claim 1, wherein processing historical user data comprises performing image analysis on one or more digital images of the certain user to identify one or more composited items associated with the user.

10. The method of claim 1, wherein processing historical user data comprises performing image analysis on one or more digital images of the certain user to identify one or more composited items associated with the user, and wherein the populating comprises populating one or more constituent items of the composited item within the composed virtual scene.

11. The method of claim 1, wherein processing historical user data comprises analyzing one or more social media posts of the user to determine aesthetic preferences, and wherein the composing comprises selecting scene lighting, color schemes, and decorations based on the determined aesthetic preferences.

12. The computer implemented method of claim 1, wherein the method includes receiving from the certain user selection data of the certain user based on an interaction of the certain user within the generated custom metaverse, where the interaction user has included the user avatar of the certain user operating under control of the certain user acquiring a virtual item within the generated metaverse by placing the virtual item within a virtual cart, wherein the method includes delivering a physical item represented by the virtual item to the certain user, the delivering including a robot operating according to first command data loading the physical item onto an autonomous vehicle at a distribution center, and the autonomous vehicle operating according to second command data autonomously transporting to the physical item to a physical address location of the certain user.

13. The computer implemented method of claim 1, wherein the processing of historical user data comprises evaluating whether a sufficiency threshold is met based on a quantity and diversity of user-specific data, and wherein, if the threshold is not met, the generating comprises performing at least one of the composing, populating, or developing in a generalized personalization mode using classification data derived from a user cluster to which the certain user is assigned, the user cluster being determined by applying a machine learning model to text-based user data to extract topic and sentiment features and grouping users based on similarity in a multi-dimensional feature space.

14. The computer implemented method of claim 1, wherein the composing comprises generating the virtual scene to replicate characteristics of a real-world venue identified as preferred by the certain user, and wherein identifying the real-world scene has included examining item acquisition data of the certain user that associates item acquisitions of the certain user to venues serving as locations of the item acquisitions.

15. The computer implemented method of claim 1, wherein the composing, populating, and the developing are performed using user classification data of the certain user when individual user data of the certain user fails to satisfy a data sufficiency threshold.

16. The computer implemented method of claim 1, wherein the composing, populating, and the developing are performed in dependence on user data of the certain user.

17. A system comprising:
a memory;
at least one processor in communication with the memory; and
program instructions executable by one or more processor via the memory to perform operations comprising:
processing historical user data;
generating a custom metaverse for a certain user in dependence on the processing, wherein the generating comprises:
composing a virtual scene;
populating the virtual scene with digital assets; and
developing a user avatar that represents the certain user;
wherein one or more of the composing, populating, or developing is performed in dependence on result data resulting from the processing historical user data.

18. The system of claim 17, wherein the developing of the avatar comprises restricting one or more aspects of avatar behavior of the user avatar in dependence on:
(a) result data derived from a set of item association rules indicating a predicted acquisition sequence of items; and
(b) result data indicating the identification of a composited item associated with the user, the composited item comprising a plurality of constituent items;
wherein the restricting comprises:
(i) triggering system-controlled movement of the avatar to a scene region containing a first item referenced as an antecedent in an item association rule and performing a predefined acquisition animation;
(ii) enabling access to a second scene region containing a consequent item only after the antecedent item has been acquired; and
(iii) limiting avatar gestures or locomotion directed toward scene areas that do not contain either predicted items or constituent items of the composited item,
wherein the avatar developing is performed in dependence on the processing historical data.

19. The system of claim 17, further comprising a client user equipment (UE) device, the client UE device receiving and installing an installation package from a server performing the generating, the installation package including rendering software, and wherein the installation package when installed configures the client UE device to render the generated metaverse generated by the generating.

20. A computer program product comprising:
a computer readable storage medium readable by one or more processing circuit and storing instructions for execution by one or more processor for performing operations comprising:
processing historical user data;
generating a custom metaverse for a certain user in dependence on the processing, wherein the generating comprises:
composing a virtual scene;
populating the virtual scene with digital assets; and
developing a user avatar that represents the certain user;
wherein one or more of the composing, populating, or developing is performed in dependence on result data resulting from the processing historical user data.
